(19) United States
(12) Patent Application Publication
(10) Pub. No.: US 2024/0409719 A1
(43) Pub. Date: Dec. 12, 2024

(54) PRECIPITATED CALCIUM CARBONATE WITH HIGH BIO-BASED CARBON CONTENT FOR POLYMER FORMULATIONS

(71) Applicant: OMYA INTERNATIONAL AG, Oftringen (CH)

(72) Inventors: Matthias WELKER, Hesingue (FR); Joris BARANGER, Kembs (FR); Karsten Udo SCHULZ, Kriens (CH); Tazio FORNERA, Zofingen (CH)

(73) Assignee: OMYA INTERNATIONAL AG, Oftringen (CH)

(21) Appl. No.: 18/720,109

(22) PCT Filed: Dec. 21, 2022
(86) PCT No.: PCT/EP2022/087336

§ 371 Date: Jun. 14, 2024

(30) Foreign Application Priority Data
Dec. 22, 2021 (EP) 21217011.2

(51) Int. Cl. C08K 9/04; C01F 11/18; C08J 3/20

(52) U.S. Cl. CPC C08K 9/04; C01F 11/181; C01F 11/185; C08J 3/203; C01P 2004/61; C01P 2006/12; C01P 2006/82; C08J 2323/06; C08J 2323/12; C08J 2367/02; C08J 2367/04; C08K 2201/005; C08K 2201/006

(57) ABSTRACT

The present invention relates to a precipitated calcium carbonate having a content of bio-based carbon determined according to DIN EN 16640:2017 of at least 50 wt.-%, based on the total weight of carbon in the precipitated calcium carbonate, a process for the preparation of the precipitated calcium carbonate, a polymer formulation comprising the precipitated calcium carbonate, an article formed from the polymer formulation, a process for preparing the article as well as the use of the precipitated calcium carbonate in a polymer formulation

The present invention relates to a precipitated calcium carbonate having a content of bio-based carbon determined according to DIN EN 16640:2017 of at least 50 wt.-%, based on the total weight of carbon in the precipitated calcium carbonate, a process for the preparation of the precipitated calcium carbonate, a polymer formulation comprising the precipitated calcium carbonate, an article formed from the polymer formulation, a process for preparing the article as well as the use of the precipitated calcium carbonate in a polymer formulation.

It is common in the art to add certain fillers to polymer compositions. For example, fillers such as calcium carbonate-comprising materials are added to polymeric products in order to improve its mechanical properties. For example, EP3192837 A1 refers to a surface-modified calcium carbonate, which is surface-treated with an anhydride or acid or salt thereof, and suggests its use inter alia in polymer compositions, papermaking, paints, adhesives, sealants, pharma applications, crosslinking of rubbers, polyolefins, polyvinyl chlorides, in unsaturated polyesters and in alkyd resins. EP2554358 A1 refers to a moisture-permeable and waterproof film that is biodegradable comprising polylactic acid and an inorganic filler. The inorganic filler is selected from the group consisting of calcium carbonate, barium carbonate, calcium sulfate, barium sulfate, magnesium hydroxide, aluminum hydroxide, calcium hydroxide, magnesium oxide, titanium oxide, zinc oxide, silicon oxide and talc.

WO2009/152427 A1 refers to a biaxially oriented laminate film including a core layer including a blend of crystalline polylactic acid polymer and an inorganic antiblock particle. EP1254766 A1 refers to multilayer films comprising a layer comprising a thermoplastic polymer, such as an aliphatic-aromatic copolyester (AAPE), with or without filler, and a layer comprising a filled thermoplastic polymer.

However, when adding fillers such as calcium carbonate to a polymer, its biobased carbon content according to EN 16640 generally decreases as e.g. calcium carbonate is not considered biobased. The foregoing is even more pronounced for the growing market of biobased polymers. But calcium carbonate can be needed to achieve the desired mechanical properties or economical viability of the products.

Therefore, there is an ongoing need for a calcium carbonate providing a high content of bio-based carbon, which is especially suitable for use in polymers.

Accordingly, it is an object of the present invention to provide a calcium carbonate having a high content of bio-based carbon. Furthermore, it is desirable that the calcium carbonate having a high content of bio-based carbon can be used in polymers, especially biobased polymers. Furthermore, it is desirable that the calcium carbonate having a high content of bio-based carbon provides sufficient properties such as mechanical properties, rheological properties and processing stability for a use in these demanding applications.

The foregoing and other objects are solved by the subject-matter as defined in the independent claims. Advantageous embodiments of the present invention are defined in the corresponding subclaims.

According to one aspect of the present invention, a precipitated calcium carbonate is provided having
a weight median particle size d₅₀ of ≤60 μm,
a top cut particle size d₉₈ of ≤500 μm, and
a residual total moisture content of ≤0.5 wt.-%, based on the total dry weight of the precipitated calcium carbonate,
wherein the precipitated calcium carbonate has a content of bio-based carbon determined according to DIN EN 16640:2017 of at least 50 wt.-%, based on the total weight of carbon in the precipitated calcium carbonate.

According to one embodiment, the precipitated calcium carbonate has
a weight median particle size d₅₀ of ≤20 μm, preferably ≤6 μm, more preferably ≤3 μm, and most preferably ≤2 μm, and/or
a top cut particle size d₉₈ of ≤200 μm, preferably ≤20 μm, more preferably ≤10 μm, and most preferably ≤8 μm, and/or
a specific surface area (BET) in the range from 1 to 50 m²/g, preferably from 2.5 to 15 m²/g, and most preferably from 3 to 9 m²/g, as measured using nitrogen and the BET method according to ISO 9277, and/or
a residual total moisture content of ≤0.3 wt.-%, preferably ≤0.2 wt.-% and most preferably ≤ 0.1 wt.-%, based on the total dry weight of the precipitated calcium carbonate, and/or
a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate.

According to another embodiment, the precipitated calcium carbonate is obtained from water decarbonization and/or water softening.

According to yet another embodiment, the precipitated calcium carbonate is a treated precipitated calcium carbonate comprising a treatment layer on the surface of the precipitated calcium carbonate, preferably the treatment layer comprises a surface-treatment agent selected from the group consisting of
I) a phosphoric acid ester blend of one or more phosphoric acid mono ester and/or salts or reaction products thereof and/or one or more phosphoric acid di-ester and/or salts or reaction products thereof, or
II) at least one saturated or unsaturated aliphatic linear or branched carboxylic acid and/or salts or reaction products thereof, preferably at least one aliphatic carboxylic acid having a total amount of carbon atoms from C4 to C24 and/or salts or reaction products thereof, more preferably at least one aliphatic carboxylic acid having a total amount of carbon atoms from C12 to C20 and/or salts or reaction products thereof, most preferably at least one aliphatic carboxylic acid having a total amount of carbon atoms from C16 to C18 and/or salts or reaction products thereof, or
III) at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof, and/or
IV) at least one polydialkylsiloxane, and/or
V) at least one cross-linkable compound comprising at least two functional groups, wherein at least one functional group is suitable for cross-linking a polymer resin and wherein at least one functional group is suitable for reacting with the precipitated calcium carbonate, and/or
VI) at least one grafted polymer comprising at least one succinic anhydride group obtained by grafting maleic anhydride onto a homo- or copolymer comprising butadiene units and optionally styrene units and/or salts or reaction products thereof, or
VII) mixtures of one or more materials according to I) to VI),
more preferably the treatment layer comprises a surface-treatment agent selected from at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof.

According to one embodiment, the treated precipitated calcium carbonate comprises the treatment layer in an amount ranging from 0.1 to 3 wt.-%, preferably from 0.1 to 1.2 wt.-% based on the total weight of the treated precipitated calcium carbonate, and/or in an amount ranging from 0.2 to 5.0 mg/m² of the BET specific surface area of the precipitated calcium carbonate and preferably from 0.5 to 3.0 mg/m² of the BET specific surface area of the precipitated calcium carbonate.

According to another embodiment, the treated precipitated calcium carbonate has
a residual total moisture content of ≤0.3 wt.-%, preferably of ≤0.2 wt.-%, and most preferably of ≤0.1 wt.-%, based on the total dry weight of the treated precipitated calcium carbonate, and/or
a moisture pick-up susceptibility of ≤6 mg/g, preferably ≤3 mg/g, more preferably ≤2 mg/g, and most preferably ≤1 mg/g, e.g. ≤0.8 mg/g, based on the total dry weight of the treated precipitated calcium carbonate.

According to another aspect, a process for the preparation of the precipitated calcium carbonate as defined herein is provided, the process comprising the steps of:
a) providing a precipitated calcium carbonate having a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the material, preferably precipitated calcium carbonate obtained from water decarbonisation and/or water softening, and
b) grinding the precipitated calcium carbonate of step a) to
   a weight median particle size d₅₀ of ≤60 μm, preferably ≤20 μm, more preferably ≤6 μm, even more preferably ≤3 μm, and most preferably ≤2 μm,
   a top cut particle size d₉₈ of ≤500 μm, preferably ≤200 μm, more preferably ≤20 μm, even more preferably ≤10 μm, and most preferably ≤8 μm.

According to one embodiment, the grinding is carried out in the absence of dispersant(s).

According to another embodiment, the grinding is a dry grinding or wet grinding, preferably wet grinding at solids content in the range from 1 to 30 wt.-%, preferably from 2 to 25 wt.-%.

According to yet another embodiment, the process further comprises step c) in which the precipitated calcium carbonate is contacted under mixing, in one or more steps, with a surface-treatment agent such that a treatment layer comprising the surface-treatment agent and/or salts or reaction products thereof is formed on the surface of the precipitated calcium carbonate.

According to one embodiment, step c) is carried out at a temperature that is at least 2° C., preferably 5° C. above the melting point of the surface-treatment agent and/or at a temperature ranging from 50 to 130° C., preferably from 60 to 120° C.

According to another embodiment, the process further comprising
d) a step of drying the precipitated calcium carbonate before and/or after grinding step b) and optionally before surface-treating step c), and/or
e) a step of dry-grinding and/or wet-grinding the precipitated calcium carbonate before grinding step b).

According to another aspect, a polymer formulation is provided comprising
a) a polymer resin, and
b) the precipitated calcium carbonate as defined herein,
wherein the precipitated calcium carbonate is dispersed in the polymer resin.

According to one embodiment, the polymer resin is selected from the group comprising polyester, polyolefin, polyamide and mixtures thereof, preferably polyethylene, polypropylene, polylactic acid, polylactic acid-based polymer, polyhydroxyalkanoates (PHA), e.g. polyhydroxybutyrate (PHB), poly-3-hydroxybutyrate (P3HB), poly3-hydroxybutyrate-co-3-hydroxyhexanoate (PHBH), polyhydroxyvalerate, polyhydroxybutyrate-polyhydroxyvalerate copolymer, poly(3-hydroxybutyrate-co-3-hydroxyvalerate) (PHBV); polybutyrate-adipate-terephthalate (PBAT), polyglyconate, polyethylene terephthalate (PET), polycarbonate (PC), poly(dioxanone), polybutylene succinate (PBS), polycaprolactone (PCL), polycaprolactone-poly(ethylene glycol) copolymer, polycaprolactone-polylactic acid copolymer, polyvinylalcohol (PVA), poly(ethylene succinate) (PES), poly(propylene succinate) (PPS), and mixtures thereof, more preferably polylactic acid, polylactic acid-based polymer, polyhydroxyalkanoates (PHA) polyethylene terephthalate (PET), and mixtures thereof or the polymer resin is an elastomer resin, preferably an elastomer resin selected from natural or synthetic rubber, more preferably from the group consisting of acrylic rubber, butadiene rubber, acrylonitrile-butadiene rubber, epichlorhydrin rubber, isoprene rubber, ethylene-propylene rubber, ethylene-propylene-diene monomer rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, thermoplastic starch (TPS), and mixtures thereof.

According to another embodiment, the polymer formulation comprises the precipitated calcium carbonate in an amount ranging from 3 to 85 wt.-%, preferably from 3 to 82 wt.-%, based on the total weight of the formulation.

According to yet another embodiment, the polymer resin is a biobased polymer resin, preferably a bio-based polyolefin, thermoplastic starch or polyester resin, and most preferably a biobased polyester.

According to one embodiment, the formulation further comprises additives such as colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin.

According to another aspect, an article formed from the polymer formulation as defined herein is provided, preferably the article is selected from the group comprising hygiene products, medical and healthcare products, filter products, geotextile products, agriculture and horticulture products, clothing, footwear and baggage products, household and industrial products, packaging products, construction products, automotive parts, bottles, cups, bags, straws, flooring products, and the like.

According to another aspect, a process for preparing an article as defined herein is provided, wherein the process comprises the steps of
a) providing a polymer resin,
b) providing a precipitated calcium carbonate as defined herein as filler,
c) optionally providing further additives such as colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin,
d) contacting the components of step a), step b), and optionally step c) in any order to form a polymer formulation, and
e) forming the polymer formulation of step d) such that an article is obtained.

According to another aspect, the use of the precipitated calcium carbonate as defined herein in a polymer formulation comprising a polymer resin is provided, preferably the polymer resin is selected from the group comprising polyester, polyolefin, polyamide and mixtures thereof, more preferably polyethylene, polypropylene, polylactic acid, polylactic acid-based polymer, polyhydroxyalkanoates (PHA), e.g. polyhydroxybutyrate (PHB), poly-3-hydroxybutyrate (P3HB), poly3-hydroxybutyrate-co-3-hydroxyhexanoate (PHBH), polyhydroxyvalerate, polyhydroxybutyrate-polyhydroxyvalerate copolymer, poly(3-hydroxybutyrate-co-3-hydroxyvalerate) (PHBV); polybutyrate-adipate-terephthalate (PBAT), polyglyconate, polyethylene terephthalate (PET), polycarbonate (PC), poly(dioxanone), polybutylene succinate (PBS), polycaprolactone (PCL), polycaprolactone-poly(ethylene glycol) copolymer, polycaprolactone-polylactic acid copolymer, polyvinylalcohol (PVA), poly(ethylene succinate) (PES), poly(propylene succinate) (PPS), and mixtures thereof, most preferably polylactic acid, polylactic acid-based polymer, polyhydroxyalkanoates (PHA) polyethylene terephthalate (PET), and mixtures thereof or the polymer resin is an elastomer resin, preferably an elastomer resin selected from natural or synthetic rubber, more preferably from the group consisting of acrylic rubber, butadiene rubber, acrylonitrile-butadiene rubber, epichlorhydrin rubber, isoprene rubber, ethylene-propylene rubber, ethylene-propylene-diene monomer rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, thermoplastic starch (TPS), and mixtures thereof.

It should be understood that for the purpose of the present invention, the following terms have the following meaning:

As used herein the term “polymer” generally includes homopolymers and co-polymers such as, for example, block, graft, random and alternating copolymers, as well as blends and modifications thereof. The polymer can be an amorphous polymer, a crystalline polymer, or a semi-crystalline polymer, i.e. a polymer comprising crystalline and amorphous fractions. The degree of crystallinity is specified in percent and can be determined by differential scanning calorimetry (DSC). An amorphous polymer may be characterized by its glass transition temperature and a crystalline polymer may be characterized by its melting point. A semi-crystalline polymer may be characterized by its glass transition temperature and/or its melting point.

The term “copolymer” as used herein refers to a polymer derived from more than one species of monomer. Copolymers that are obtained by copolymerization of two monomer species may also be termed bipolymers, those obtained from three monomers terpolymers, those obtained from four monomers quaterpolymers, etc. (cf. IUPAC Compendium of Chemical Terminology 2014, “copolymer”). Accordingly, the term “homopolymer” refers to a polymer derived from one species of monomer.

The term “glass transition temperature” in the meaning of the present invention refers to the temperature at which the glass transition occurs, which is a reversible transition in amorphous materials (or in amorphous regions within semi-crystalline materials) from a hard and relatively brittle state into a molten or rubber-like state. The glass-transition temperature is always lower than the melting point of the crystalline state of the material, if one exists. The term “melting point” in the meaning of the present invention refers to the temperature at which a solid changes state from solid to liquid at atmospheric pressure. At the melting point, the solid and liquid phase exist in equilibrium. Glass-transition temperature and melting point are determined by ISO 11357 with a heating rate of 10° C./min.

The term “treated” or “surface-treated” in the meaning of the present invention refers to a material which has been contacted with a surface treatment agent such as to obtain a coating layer on at least a part of the surface of the material.

The “particle size” of particulate materials is described herein by its weight-based distribution of particle sizes dx. Therein, the value dx represents the diameter relative to which x % by weight of the particles have diameters less than dx. This means that, for example, the do value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀ (wt) unless indicated otherwise. Particle sizes were determined by using a Sedigraph™ 5120 instrument of Micromeritics Instrument Corporation. The method and the instrument are known to the skilled person and are commonly used to determine the particle size of fillers and pigments. The measurements were carried out in an aqueous solution of 0.1 wt.-% Na₄P₂O₇.

The “content of bio-based carbon” as used throughout the present application is determined according to DIN EN 16640:2017 as a fraction of total carbon. It is to be noted that in case of a treated material, the bio-based carbon content is determined on the (surface-) treated precipitated calcium carbonate.

The “specific surface area” (expressed in m²/g) of a material as used throughout the present application can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 30 min prior to measurement. The total surface area (in m²) of said material can be obtained by multiplication of the specific surface area (in m²/g) and the mass (in g) of the material.

Unless specified otherwise, the term “drying” refers to a process according to which at least a portion of water is removed from a material to be dried such that a constant weight of the obtained “dried” material at 200° C. is reached. Moreover, a “dried” or “dry” material may be defined by its total moisture content which, unless specified otherwise, is generally less than or equal to 1.0 wt.-%, preferably ≤0.8 wt.-%, more preferably ≤0.5 wt.-% and most preferably ≤0.3 wt.-%, based on the total weight of the dried material. The foregoing especially refers to intermediate products obtained by the process for the preparation of the precipitated calcium carbonate as defined herein. As regards the precipitated calcium carbonate of the present invention, the “dried” or “dry” precipitated calcium carbonate has a total moisture content of less than or equal to 0.5 wt. %, preferably ≤0.3 wt.-%, more preferably ≤0.2 wt.-% and most preferably ≤0.1 wt.-%, based on the total weight of the dried material.

For the purpose of the present invention, the term “viscosity” or “Brookfield viscosity” refers to Brookfield viscosity. The Brookfield viscosity can for this purpose be measured by a Brookfield DV-II+Pro viscometer at 25° C.±1° C. at 100 rpm using an appropriate spindle of the Brookfield RV-spindle set and is specified in mPa·s or cPs. Based on his technical knowledge, the skilled person will select a spindle from the Brookfield RV-spindle set which is suitable for the viscosity range to be measured. For example, for a Brookfield viscosity range between 200 and 800 mPa·s the spindle number 3 may be used, for a viscosity range between 400 and 1 600 mPa·s the spindle number 4 may be used, for a viscosity range between 800 and 3 200 mPa·s the spindle number 5 may be used, for a viscosity range between 1 000 and 2 000 000 mPa·s the spindle number 6 may be used, and for a viscosity range between 4 000 and 8 000 000 mPa·s the spindle number 7 may be used.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

The precipitated calcium carbonate of the present invention has

a weight median particle size d₅₀ of ≤60 μm,
a top cut particle size d₉₈ of ≤500 μm, and
a residual total moisture content of ≤0.5 wt.-%, based on the total dry weight of the precipitated calcium carbonate,
wherein the precipitated calcium carbonate has a content of bio-based carbon determined according to DIN EN 16640:2017 of at least 50 wt.-%, based on the total weight of carbon in the precipitated calcium carbonate.

In the following, preferred embodiments of the inventive products will be set out in more detail. It is to be understood that these embodiments and details also apply to the inventive methods for their preparation and their uses described herein.

### The Precipitated Calcium Carbonate

The precipitated calcium carbonate of the present invention has a content of bio-based carbon determined according to DIN EN 16640:2017 of at least 50 wt.-%, based on the total weight of carbon in the precipitated calcium carbonate.

For example, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate.

In addition thereto, the precipitated calcium carbonate has
a weight median particle size d₅₀ of ≤60 μm,
a top cut particle size d₉₈ of ≤500 μm, and
a residual total moisture content of ≤0.5 wt.-%, based on the total dry weight of the precipitated calcium carbonate.

For example, the precipitated calcium carbonate has a weight median particle size d₅₀ of ≤20 μm, preferably ≤6 μm, more preferably ≤3 μm, and most preferably ≤2 μm.

Additionally or alternatively, the precipitated calcium carbonate has a top cut particle size d₉₈ of ≤200 μm, preferably ≤20 μm, more preferably ≤10 μm, and most preferably ≤8 μm.

Additionally or alternatively, the precipitated calcium carbonate has a residual total moisture content of ≤0.3 wt.-%, preferably ≤0.2 wt.-% and most preferably ≤0.1 wt.-%, based on the total dry weight of the precipitated calcium carbonate.

Thus, the precipitated calcium carbonate has
a weight median particle size d₅₀ of ≤60 μm, preferably ≤20 μm, more preferably ≤6 μm, even more preferably ≤3 μm, and most preferably ≤2 μm, and
a top cut particle size dos of ≤500 μm, preferably ≤200 μm, more preferably ≤20 μm, even more preferably ≤10 μm, and most preferably ≤8 μm, and
a residual total moisture content of ≤0.5 wt.-%, preferably ≤0.3 wt.-%, more preferably ≤0.2 wt.-% and most preferably ≤0.1 wt.-%, based on the total dry weight of the precipitated calcium carbonate, and
a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate.

In one embodiment, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and/or
a top cut particle size d₉₈ of ≤200 μm, preferably ≤20 μm, more preferably ≤10 μm, and most preferably ≤8 μm, and/or
a residual total moisture content of ≤0.3 wt.-%, preferably ≤0.2 wt.-% and most preferably ≤ 0.1 wt.-%, based on the total dry weight of the precipitated calcium carbonate.

For example, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate.

For example, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, or
a top cut particle size d₉₈ of ≤8 μm, or
a residual total moisture content of ≤0.1 wt.-%, based on the total dry weight of the precipitated calcium carbonate.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, and
a top cut particle size d₉₈ of ≤8 μm, or
a residual total moisture content of ≤0.1 wt.-%, based on the total dry weight of the precipitated calcium carbonate.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, or
a top cut particle size d₉₈ of ≤8 μm, and
a residual total moisture content of ≤0.1 wt.-%, based on the total dry weight of the precipitated calcium carbonate.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, and
a top cut particle size d₉₈ of ≤8 μm, and
a residual total moisture content of ≤0.1 wt.-%, based on the total dry weight of the precipitated calcium carbonate.

Preferably, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₆₀ of ≤20 μm, preferably ≤6 μm, more preferably ≤3 μm, and most preferably ≤2 μm, and/or
a top cut particle size dos of ≤200 μm, preferably ≤20 μm, more preferably ≤10 μm, and most preferably ≤8 μm, and/or
a residual total moisture content of ≤0.3 wt.-%, preferably ≤0.2 wt.-% and most preferably ≤ 0.1 wt.-%, based on the total dry weight of the precipitated calcium carbonate.

For example, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size des of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₆₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate.

For example, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, or
a top cut particle size d₉₈ of ≤8 μm, or
a residual total moisture content of ≤0.1 wt.-%, based on the total dry weight of the precipitated calcium carbonate.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, and
a top cut particle size d₉₈ of ≤8 μm, or
a residual total moisture content of ≤0.1 wt.-%, based on the total dry weight of the precipitated calcium carbonate.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, or
a top cut particle size d₉₈ of ≤8 μm, and
a residual total moisture content of ≤0.1 wt.-%, based on the total dry weight of the precipitated calcium carbonate

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, and
a top cut particle size d₉₈ of ≤8 μm, and
a residual total moisture content of ≤0.1 wt.-%, based on the total dry weight of the precipitated calcium carbonate.

In one embodiment, the precipitated calcium carbonate has a specific surface area (BET) in the range from 1 to 50 m²/g, preferably from 2.5 to 15 m²/g, and most preferably from 3 to 9 m²/g, as measured using nitrogen and the BET method according to ISO 9277.

Thus, in one embodiment, the precipitated calcium carbonate has a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate, and a specific surface area (BET) in the range from 1 to 50 m²/g, preferably from 2.5 to 15 m²/g, and most preferably from 3 to 9 m²/g, as measured using nitrogen and the BET method according to ISO 9277.

In another embodiment, the precipitated calcium carbonate has
a weight median particle size d₅₀ of ≤60 μm, preferably ≤20 μm, more preferably ≤6 μm, even more preferably ≤3 μm, and most preferably ≤2 μm, and
a top cut particle size d₉₈ of ≤500 μm, preferably ≤200 μm, more preferably ≤20 μm, even more preferably ≤10 μm, and most preferably ≤8 μm and
a residual total moisture content of ≤0.5 wt.-%, preferably ≤0.3 wt.-%, more preferably ≤0.2 wt.-% and most preferably ≤0.1 wt.-%, based on the total dry weight of the precipitated calcium carbonate, and
a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate, and
a specific surface area (BET) in the range from 1 to 50 m²/g, preferably 2.5 to 15 m²/g, and most preferably from 3 to 9 m²/g, as measured using nitrogen and the BET method according to ISO 9277.

For example, the precipitated calcium carbonate has a content of bio-based carbon determined according to DIN EN 16640:2017 of at least 50 wt.-%, based on the total weight of carbon in the precipitated calcium carbonate, and
a weight median particle size d₆₀ of ≤20 μm, preferably ≤6 μm, more preferably ≤3 μm, and most preferably ≤2 μm, and/or
a top cut particle size d₉₈ of ≤200 μm, preferably ≤20 μm, more preferably ≤10 μm, and most preferably ≤8 μm, and/or
a residual total moisture content of ≤0.3 wt.-%, preferably ≤0.2 wt.-% and most preferably ≤ 0.1 wt.-%, based on the total dry weight of the precipitated calcium carbonate, and/or
a specific surface area (BET) in the range from 1 to 50 m²/g, preferably from 2.5 to 15 m²/g, and most preferably from 3 to 9 m²/g, as measured using nitrogen and the BET method according to ISO 9277.

For example, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate, or
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate, or
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate, and
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate, or
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and

a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate, and
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate, and
a specific surface area (BET) in the range from 1 to 50 m²/g, preferably from 2.5 to 15 m²/g, and most preferably from 3 to 9 m²/g, as measured using nitrogen and the BET method according to ISO 9277.

For example, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, or
a top cut particle size d₉₈ of ≤8 μm, or
a residual total moisture content of ≤0.1 wt.-%, based on the total dry weight of the precipitated calcium carbonate, or
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, and
a top cut particle size d₉₈ of ≤8 μm, or
a residual total moisture content of ≤0.1 wt.-%, based on the total dry weight of the precipitated calcium carbonate, or
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, or
a top cut particle size d₉₈ of ≤8 μm, and
a residual total moisture content of ≤0.1 wt.-%, based on the total dry weight of the precipitated calcium carbonate, and
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, or
a top cut particle size d₉₈ of ≤8 μm, and
a residual total moisture content of ≤0.1 wt.-%, based on the total dry weight of the precipitated calcium carbonate, or
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, and
a top cut particle size d₉₈ of ≤8 μm, or
a residual total moisture content of ≤0.1 wt.-%, based on the total dry weight of the precipitated calcium carbonate, and
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 50 wt.-%, based on the total weight of carbon in the precipitated calcium carbonate, and
a weight median particle size d₅₀ of ≤2 μm, and
a top cut particle size d₉₈ of ≤8 μm, and
a residual total moisture content of ≤0.1 wt.-%, based on the total dry weight of the precipitated calcium carbonate, and
a specific surface area (BET) in the range from 3 to 9 m²/g, as measured using nitrogen and the BET method according to ISO 9277.

Preferably, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and/or
a top cut particle size d₉₈ of ≤200 μm, preferably ≤20 μm, more preferably ≤10 μm, and most preferably ≤8 μm, and/or
a residual total moisture content of ≤0.3 wt.-%, preferably ≤0.2 wt.-% and most preferably ≤ 0.1 wt.-%, based on the total dry weight of the precipitated calcium carbonate, and/or
a specific surface area (BET) in the range from 1 to 50 m²/g, preferably from 2.5 to 15 m²/g, and most preferably from 3 to 9 m²/g, as measured using nitrogen and the BET method according to ISO 9277.

For example, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate, or
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate, or
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size d₉₈ of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate, and
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, or
a top cut particle size dos of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate, or
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size d₉₈ of ≤200 μm, preferably ≤20 μm, more preferably ≤10 μm, and most preferably ≤8 μm, or
a residual total moisture content of ≤0.3 wt.-%, preferably ≤0.2 wt.-% and most preferably ≤ 0.1 wt.-%, based on the total dry weight of the precipitated calcium carbonate, and
a specific surface area (BET) in the range from 1 to 50 m²/g, preferably from 2.5 to 15 m²/g, and most preferably from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤20 μm, preferably ≤6 μm, more preferably ≤3 μm, and most preferably ≤2 μm, and
a top cut particle size des of ≤200 μm, preferably ≤20 μm, more preferably ≤10 μm, and most preferably ≤8 μm, and
a residual total moisture content of ≤0.3 wt.-%, preferably ≤0.2 wt.-% and most preferably ≤ 0.1 wt.-%, based on the total dry weight of the precipitated calcium carbonate, and
a specific surface area (BET) in the range from 1 to 50 m²/g, preferably from 2.5 to 15 m²/g, and most preferably from 3 to 9 m²/g, as measured using nitrogen and the BET method according to ISO 9277.

For example, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, or
a top cut particle size d₉₈ of ≤8 μm, or
a residual total moisture content of ≤0.1 wt.-%, based on the total dry weight of the precipitated calcium carbonate, or
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, and
a top cut particle size d₉₈ of ≤8 μm, or
a residual total moisture content of ≤0.1 wt.-%, based on the total dry weight of the precipitated calcium carbonate, or
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, or
a top cut particle size d₉₈ of ≤8 μm, and
a residual total moisture content of ≤0.1 wt.-%, based on the total dry weight of the precipitated calcium carbonate, and
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, or
a top cut particle size d₉₈ of ≤8 μm, and
a residual total moisture content of ≤0.1 wt.-%, based on the total dry weight of the precipitated calcium carbonate, or
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, and
a top cut particle size d₉₈ of ≤8 μm, or
a residual total moisture content of ≤0.1 wt.-%, based on the total dry weight of the precipitated calcium carbonate, and
a specific surface area (BET) in the range from 3 to 9 m²/g, as measured using nitrogen and the BET method according to ISO 9277.

Alternatively, the precipitated calcium carbonate has a content of bio-based carbon determined according to DIN EN 16640:2017 of at least 60 wt.-%, more preferably at least 65 wt.-%, and most preferably at least 70 wt.-%, based on the total weight of carbon in the precipitated calcium carbonate, and
a weight median particle size d₅₀ of ≤2 μm, and
a top cut particle size d₉₈ of ≤8 μm, and
a residual total moisture content of ≤0.1 wt.-%, based on the total dry weight of the precipitated calcium carbonate, and
a specific surface area (BET) in the range from 3 to 9 m²/g, as measured using nitrogen and the BET method according to ISO 9277.

It is appreciated that the precipitated calcium carbonate is obtained from water decarbonization and/or water softening, preferably from water decarbonization. Preferably, the precipitated calcium carbonate is obtained from fast water decarbonization. It is to be noted that water softening refers to a process in which calcium ions are primarily removed, whereas water decarbonization refers to a process in which carbon dioxide is primarily removed. Thus, water decarbonization and/or water softening is/are preferably carried out by carbonation of calcium hydroxide e.g. in a water decarbonization unit and/or water softening unit. Preferably, water decarbonization is carried out by carbonation of calcium hydroxide e.g. in a water decarbonization unit. More preferably, water decarbonization is a fast water decarbonization that is carried out by carbonation of calcium hydroxide e.g. in a water decarbonization unit, preferably in the presence of seed crystals.

It is appreciated that the skilled person is aware of methods used for fast water decarbonization such as using seed crystals for reducing the reaction time. In such a fast water decarbonization, water added with calcium hydroxide preferably flows through a fluidized bed of seed crystals in upstream.

This is advantageous for obtaining a precipitated calcium carbonate having a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate.

As the precipitated calcium carbonate is obtained from water decarbonization and/or water softening, the precipitated calcium carbonate can contain up to 5 wt.-%, based on the total weight of the precipitated calcium carbonate, of quartz and/or ground natural calcium carbonate such as chalk, limestone and/or marble, preferably quartz or ground natural calcium carbonate such as chalk, limestone and/or marble.

The precipitated calcium carbonate in the meaning of the present invention is thus a synthesized material, generally obtained by precipitation of a calcium- and a carbonate source in water. The precipitated calcium carbonate may be vaterite, calcite or aragonite.

In one embodiment, the precipitated calcium carbonate is a treated precipitated calcium carbonate. That is to say, the precipitated calcium carbonate is a treated precipitated calcium carbonate comprising a treatment layer on the surface of the precipitated calcium carbonate.

It is preferred that the treatment layer comprises a surface-treatment agent selected from the group consisting of
I) a phosphoric acid ester blend of one or more phosphoric acid mono ester and/or salts or reaction products thereof and/or one or more phosphoric acid di-ester and/or salts or reaction products thereof, or
II) at least one saturated or unsaturated aliphatic linear or branched carboxylic acid and/or salts or reaction products thereof, preferably at least one aliphatic carboxylic acid having a total amount of carbon atoms from C4 to C24 and/or salts or reaction products thereof, more preferably at least one aliphatic carboxylic acid having a total amount of carbon atoms from C12 to C20 and/or salts or reaction products thereof, most preferably at least one aliphatic carboxylic acid having a total amount of carbon atoms from C16 to C18 and/or salts or reaction products thereof, or
III) at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof, and/or
IV) at least one polydialkylsiloxane, and/or
V) at least one cross-linkable compound comprising at least two functional groups, wherein at least one functional group is suitable for cross-linking a polymer resin and wherein at least one functional group is suitable for reacting with the precipitated calcium carbonate, and/or
VI) at least one grafted polymer comprising at least one succinic anhydride group obtained by grafting maleic anhydride onto a homo- or copolymer comprising butadiene units and optionally styrene units and/or salts or reaction products thereof, or
VII) mixtures of one or more materials according to I) to VI).

It is appreciated that the bio-based carbon content of the treated precipitated calcium carbonate is at most 15%, preferably at most 10 wt.-% and most preferably at most 5 wt.-% below the bio-based carbon content of the untreated precipitated calcium carbonate.

In a preferred embodiment, the treatment layer comprises a surface-treatment agent selected from at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof.

According to one embodiment of the present invention, the surface-treatment agent is a phosphoric acid ester blend of one or more phosphoric acid mono-ester and/or salts or reaction products thereof and/or one or more phosphoric acid di-ester and/or salts or reaction products thereof.

In one embodiment of the present invention, the one or more phosphoric acid mono-ester consists of an o-phosphoric acid molecule esterified with one alcohol selected from saturated, branched or linear, aliphatic or aromatic alcohols having a total amount of carbon atoms from C6 to C30 in the alcohol substituent. For example, the one or more phosphoric acid mono-ester consists of an o-phosphoric acid molecule esterified with one alcohol selected from saturated, branched or linear, aliphatic or aromatic alcohols having a total amount of carbon atoms from C8 to C22, more preferably from C8 to C20 and most preferably from C8 to C18 in the alcohol substituent.

Alkyl esters of phosphoric acid are well known in the industry especially as surfactants, lubricants and antistatic agents (Die Tenside; Kosswig und Stache, Carl Hanser Verlag München, 1993).

The synthesis of alkyl esters of phosphoric acid by different methods and the surface treatment of minerals with alkyl esters of phosphoric acid are well known by the skilled man, e.g. from Pesticide Formulations and Application Systems: 17th Volume; Collins HM, Hall FR, Hopkinson M, STP1268; Published: 1996, US3,897,519A, US4,921,990 A, US4,350,645 A, US6,710,199 B2, US4,126,650 A, US5,554,781 A, EP 1092000 B1 and WO 2008/023076 A1.

In one embodiment of the present invention, the one or more phosphoric acid mono-ester consists of an o-phosphoric acid molecule esterified with one alcohol selected from saturated and linear or branched and aliphatic alcohols having a total amount of carbon atoms from C6 to C30 in the alcohol substituent. For example, the one or more phosphoric acid mono-ester consists of an o-phosphoric acid molecule esterified with one alcohol selected from saturated and linear or branched and aliphatic alcohols having a total amount of carbon atoms from C8 to C22, more preferably from C8 to C20 and most preferably from C8 to C18 in the alcohol substituent.

In one embodiment of the present invention, the one or more phosphoric acid mono-ester consists of an o-phosphoric acid molecule esterified with one alcohol selected from saturated and linear and aliphatic alcohols having a total amount of carbon atoms from C6 to C30, preferably from C8 to C22, more preferably from C8 to C20 and most preferably from C8 to C18 in the alcohol substituent. Alternatively, the one or more phosphoric acid mono-ester consists of an o-phosphoric acid molecule esterified with one alcohol selected from saturated and branched and aliphatic alcohols having a total amount of carbon atoms from C6 to C30, preferably from C8 to C22, more preferably from C8 to C20 and most preferably from C8 to C18 in the alcohol substituent.

In one embodiment of the present invention, the one or more phosphoric acid mono-ester is selected from the group comprising hexyl phosphoric acid mono-ester, heptyl phosphoric acid mono-ester, octyl phosphoric acid mono-ester, 2-ethylhexyl phosphoric acid mono-ester, nonyl phosphoric acid mono-ester, decyl phosphoric acid mono-ester, undecyl phosphoric acid mono-ester, dodecyl phosphoric acid mono-ester, tetradecyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof.

For example, the one or more phosphoric acid mono-ester is selected from the group comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof. In one embodiment of the present invention, the one or more phosphoric acid mono-ester is 2-octyl-1-dodecylphosphoric acid mono-ester.

It is appreciated that the expression “one or more” phosphoric acid di-ester means that one or more kinds of phosphoric acid di-ester may be present in the treatment layer of the surface-treated material product and/or the phosphoric acid ester blend.

Accordingly, it should be noted that the one or more phosphoric acid di-ester may be one kind of phosphoric acid di-ester. Alternatively, the one or more phosphoric acid di-ester may be a mixture of two or more kinds of phosphoric acid di-ester. For example, the one or more phosphoric acid di-ester may be a mixture of two or three kinds of phosphoric acid di-ester, like two kinds of phosphoric acid di-ester.

In one embodiment of the present invention, the one or more phosphoric acid di-ester consists of an o-phosphoric acid molecule esterified with two alcohols selected from saturated, branched or linear, aliphatic or aromatic alcohols having a total amount of carbon atoms from C6 to C30 in the alcohol substituent. For example, the one or more phosphoric acid di-ester consists of an o-phosphoric acid molecule esterified with two fatty alcohols selected from saturated, branched or linear, aliphatic or aromatic alcohols having a total amount of carbon atoms from C8 to C22, more preferably from C8 to C20 and most preferably from C8 to C18 in the alcohol substituent.

It is appreciated that the two alcohols used for esterifying the phosphoric acid may be independently selected from the same or different saturated, branched or linear, aliphatic or aromatic alcohols having a total amount of carbon atoms from C6 to C30 in the alcohol substituent. In other words, the one or more phosphoric acid di-ester may comprise two substituents being derived from the same alcohols or the phosphoric acid di-ester molecule may comprise two substituents being derived from different alcohols.

In one embodiment of the present invention, the one or more phosphoric acid di-ester consists of an o-phosphoric acid molecule esterified with two alcohols selected from the same or different, saturated and linear or branched and aliphatic alcohols having a total amount of carbon atoms from C6 to C30 in the alcohol substituent. For example, the one or more phosphoric acid di-ester consists of an o-phosphoric acid molecule esterified with two alcohols selected from the same or different, saturated and linear or branched and aliphatic alcohols having a total amount of carbon atoms from C8 to C22, more preferably from C8 to C20 and most preferably from C8 to C18 in the alcohol substituent.

In one embodiment of the present invention, the one or more phosphoric acid di-ester consists of an o-phosphoric acid molecule esterified with two alcohols selected from the same or different, saturated and linear and aliphatic alcohols having a total amount of carbon atoms from C6 to C30, preferably from C8 to C22, more preferably from C8 to C20 and most preferably from C8 to C18 in the alcohol substituent. Alternatively, the one or more phosphoric acid di-ester consists of an o-phosphoric acid molecule esterified with two alcohols selected from the same or different, saturated and branched and aliphatic alcohols having a total amount of carbon atoms from C6 to C30, preferably from C8 to C22, more preferably from C8 to C20 and most preferably from C8 to C18 in the alcohol substituent.

In one embodiment of the present invention, the one or more phosphoric acid di-ester is selected from the group comprising hexyl phosphoric acid di-ester, heptyl phosphoric acid di-ester, octyl phosphoric acid di-ester, 2-ethylhexyl phosphoric acid di-ester, nonyl phosphoric acid di-ester, decyl phosphoric acid di-ester, undecyl phosphoric acid di-ester, dodecyl phosphoric acid di-ester, tetradecyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof.

For example, the one or more phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof. In one embodiment of the present invention, the one or more phosphoric acid di-ester is 2-octyl-1-dodecylphosphoric acid di-ester.

In one embodiment of the present invention, the one or more phosphoric acid mono-ester is selected from the group comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof and the one or more phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof.

According to another embodiment of the present invention, the surface-treatment agent is at least one saturated or unsaturated aliphatic linear or branched carboxylic acid and/or salts or reaction products thereof preferably at least one aliphatic carboxylic acid having a total amount of carbon atoms from C4 to C24 and/or salts or reaction products thereof, more preferably at least one aliphatic carboxylic acid having a total amount of carbon atoms from C12 to C20 and/or salts or reaction products thereof, most preferably at least one aliphatic carboxylic acid having a total amount of carbon atoms from C16 to C18 and/or salts or reaction products thereof.

The carboxylic acid in the meaning of the present invention may be selected from one or more linear chain, branched chain, saturated, or unsaturated and/or alicyclic carboxylic acids. Preferably, the aliphatic carboxylic acid is a monocarboxylic acid, i.e. the aliphatic carboxylic acid is characterized in that a single carboxyl group is present. Said carboxyl group is placed at the end of the carbon skeleton.

In one embodiment of the present invention, the aliphatic linear or branched carboxylic acid and/or salt thereof is selected from saturated unbranched carboxylic acids, preferably selected from the group of carboxylic acids consisting of pentanoic acid, hexanoic acid, heptanoic acid, octanoic acid, nonanoic acid, decanoic acid, undecanoic acid, lauric acid, tridecanoic acid, myristic acid, pentadecanoic acid, palmitic acid, heptadecanoic acid, stearic acid, nonadecanoic acid, arachidic acid, heneicosylic acid, behenic acid, tricosylic acid, lignoceric acid, their salts, their anhydrides and mixtures thereof.

In another embodiment of the present invention, the aliphatic linear or branched carboxylic acid and/or salt thereof is selected from the group consisting of octanoic acid, decanoic acid, lauric acid, myristic acid, palmitic acid, stearic acid, arachidic acid and mixtures thereof. Preferably, the aliphatic carboxylic acid is selected from the group consisting of myristic acid, palmitic acid, stearic acid, their salts, their anhydrides and mixtures thereof.

Preferably, the aliphatic carboxylic acid and/or a salt or anhydride thereof is stearic acid and/or a stearic acid salt or stearic anhydride.

Alternatively, the unsaturated aliphatic linear or branched carboxylic acid is preferably selected from the group consisting of myristoleic acid, palmitoleic acid, sapienic acid, oleic acid, elaidic acid, vaccenic acid, linoleic acid, α-linolenic acid, eicosapentaenoic acid, docosahexaenoic acid and mixtures thereof. More preferably, the unsaturated aliphatic linear or branched carboxylic acid selected from the group consisting of myristoleic acid, palmitoleic acid, sapienic acid, oleic acid, elaidic acid, vaccenic acid, linoleic acid, α-linolenic acid and mixtures thereof. Most preferably, the unsaturated aliphatic linear or branched carboxylic acid is oleic acid and/or linoleic acid, preferably oleic acid or linoleic acid, most preferably linoleic acid.

Additionally or alternatively, the surface treatment agent is a salt of an unsaturated aliphatic linear or branched carboxylic acid.

The term “salt of an unsaturated aliphatic linear or branched carboxylic acid” refers to an unsaturated fatty acid, wherein the active acid group is partially or completely neutralized. The term “partially neutralized” unsaturated aliphatic linear or branched carboxylic acid refers to a degree of neutralization of the active acid groups in the range from 40 and 95 mole-% preferably from 50 to 95 mole-%, more preferably from 60 to 95 mole-% and most preferably from 70 to 95 mole-%. The term “completely neutralized” unsaturated aliphatic linear or branched carboxylic acid refers to a degree of neutralization of the active acid groups of >95 mole-%, preferably of >99 mole-%, more preferably of >99.8 mole-% and most preferably of 100 mole-%. Preferably, the active acid groups are partially or completely neutralized.

The salt of unsaturated aliphatic linear or branched carboxylic acid is preferably a compound selected from the group consisting of sodium, potassium, calcium, magnesium, lithium, strontium, primary amine, secondary amine, tertiary amine and/or ammonium salts thereof, whereby the amine salts are linear or cyclic. For example, the unsaturated aliphatic linear or branched carboxylic acid is a salt of oleic acid and/or linoleic acid, preferably oleic acid or linoleic acid, most preferably linoleic acid.

According to another embodiment of the present invention, the surface-treatment agent is at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof. Preferably, the surface-treatment agent is at least one mono-substituted succinic anhydride consisting of succinic anhydride mono-substituted with a group being a linear aliphatic group having a total amount of carbon atoms from at least C2 to C30 in the substituent and/or salts or reaction products thereof. Additionally or alternatively, the surface-treatment agent is at least one mono-substituted succinic anhydride consisting of succinic anhydride mono-substituted with a group being a branched aliphatic group having a total amount of carbon atoms from at least C3 to C30 in the substituent and/or salts or reaction products thereof. Additionally or alternatively, the surface-treatment agent is at least one mono-substituted succinic anhydride consisting of succinic anhydride mono-substituted with a group being a cyclic aliphatic group having a total amount of carbon atoms from at least C5 to C30 in the substituent and/or salts or reaction products thereof.

Accordingly, it should be noted that the at least one mono-substituted succinic anhydride may be one kind of mono-substituted succinic anhydride. Alternatively, the at least one mono-substituted succinic anhydride may be a mixture of two or more kinds of mono-substituted succinic anhydride. For example, the at least one mono-substituted succinic anhydride may be a mixture of two or three kinds of mono-substituted succinic anhydride, like two kinds of mono-substituted succinic anhydride.

In one embodiment of the present invention, the at least one mono-substituted succinic anhydride is one kind of mono-substituted succinic anhydride.

It is appreciated that the at least one mono-substituted succinic anhydride represents a surface treatment agent and consists of succinic anhydride mono-substituted with a group selected from any linear, branched, aliphatic, and cyclic group having a total amount of carbon atoms from C2 to C30 in the substituent.

In one embodiment of the present invention, the at least one mono-substituted succinic anhydride consists of succinic anhydride mono-substituted with a group selected from a linear, branched, aliphatic, and cyclic group having a total amount of carbon atoms from C3 to C20 in the substituent. For example, the at least one mono-substituted succinic anhydride consists of succinic anhydride mono-substituted with a group selected from a linear, branched, aliphatic, and cyclic group having a total amount of carbon atoms from C4 to C18 in the substituent. Preferably, the surface-treatment agent is at least one mono-substituted succinic anhydride consisting of succinic anhydride mono-substituted with a group being a linear aliphatic group having a total amount of carbon atoms from C3 to C20, more preferably from C4 to C18, in the substituent and/or salts or reaction products thereof. Additionally or alternatively, the surface-treatment agent is at least one mono-substituted succinic anhydride consisting of succinic anhydride mono-substituted with a group being a branched aliphatic group having a total amount of carbon atoms from C3 to C20, more preferably from C4 to C18, in the substituent and/or salts or reaction products thereof. Additionally or alternatively, the surface-treatment agent is at least one mono-substituted succinic anhydride consisting of succinic anhydride mono-substituted with a group being a cyclic aliphatic group having a total amount of carbon atoms from C5 to C20, more preferably from C5 to C18 in the substituent and/or salts or reaction products thereof.

In one embodiment of the present invention, the at least one mono-substituted succinic anhydride consists of succinic anhydride mono-substituted with one group being a linear and aliphatic group having a total amount of carbon atoms from C2 to C30, preferably from C3 to C20 and most preferably from C4 to C18 in the substituent. Additionally or alternatively, the at least one mono-substituted succinic anhydride consists of succinic anhydride mono-substituted with one group being a branched and aliphatic group having a total amount of carbon atoms from C3 to C30, preferably from C3 to C20 and most preferably from C4 to C18 in the substituent.

Thus, it is preferred that the at least one mono-substituted succinic anhydride consists of succinic anhydride mono-substituted with one group being a linear alkyl group having a total amount of carbon atoms from C2 to C30, preferably from C3 to C20 and most preferably from C4 to C18 in the substituent. Additionally or alternatively, it is preferred that the at least one mono-substituted succinic anhydride consists of succinic anhydride mono-substituted with one group being a branched alkyl group having a total amount of carbon atoms from C3 to C30, preferably from C3 to C20 and most preferably from C4 to C18 in the substituent.

For example, the at least one mono-substituted succinic anhydride consists of succinic anhydride mono-substituted with one group being a linear alkyl group having a total amount of carbon atoms from C2 to C30, preferably from C3 to C20 and most preferably from C4 to C18 in the substituent. Additionally or alternatively, the at least one mono-substituted succinic anhydride consists of succinic anhydride mono-substituted with one group being a branched alkyl group having a total amount of carbon atoms from C3 to C30, preferably from C3 to C20 and most preferably from C4 to C18 in the substituent.

In one embodiment of the present invention, the at least one mono-substituted succinic anhydride is at least one linear or branched alkyl mono-substituted succinic anhydride. For example, the at least one alkyl mono-substituted succinic anhydride is selected from the group comprising ethylsuccinic anhydride, propylsuccinic anhydride, butylsuccinic anhydride, triisobutyl succinic anhydride, pentylsuccinic anhydride, hexylsuccinic anhydride, heptylsuccinic anhydride, octylsuccinic anhydride, nonylsuccinic anhydride, decyl succinic anhydride, dodecyl succinic anhydride, hexadecanyl succinic anhydride, octadecanyl succinic anhydride, and mixtures thereof.

Accordingly, it is appreciated that, e.g., the term “butylsuccinic anhydride” comprises linear and branched butylsuccinic anhydride(s). One specific example of linear butylsuccinic anhydride(s) is n-butylsuccinic anhydride. Specific examples of branched butylsuccinic anhydride(s) are iso-butylsuccinic anhydride, sec-butylsuccinic anhydride and/or tert-butylsuccinic anhydride.

Furthermore, it is appreciated that, e.g., the term “hexadecanyl succinic anhydride” comprises linear and branched hexadecanyl succinic anhydride(s). One specific example of linear hexadecanyl succinic anhydride(s) is n-hexadecanyl succinic anhydride. Specific examples of branched hexadecanyl succinic anhydride(s) are 14-methylpentadecanyl succinic anhydride, 13-methylpentadecanyl succinic anhydride, 12-methylpentadecanyl succinic anhydride, 11-methylpentadecanyl succinic anhydride, 10-methylpentadecanyl succinic anhydride, 9-methylpentadecanyl succinic anhydride, 8-methylpentadecanyl succinic anhydride, 7-methylpentadecanyl succinic anhydride, 6-methylpentadecanyl succinic anhydride, 5-methylpentadecanyl succinic anhydride, 4-methylpentadecanyl succinic anhydride, 3-methylpentadecanyl succinic anhydride, 2-methylpentadecanyl succinic anhydride, 1-methylpentadecanyl succinic anhydride, 13-ethylbutadecanyl succinic anhydride, 12-ethylbutadecanyl succinic anhydride, 11-ethylbutadecanyl succinic anhydride, 10-ethylbutadecanyl succinic anhydride, 9-ethylbutadecanyl succinic anhydride, 8-ethylbutadecanyl succinic anhydride, 7-ethylbutadecanyl succinic anhydride, 6-ethylbutadecanyl succinic anhydride, 5-ethylbutadecanyl succinic anhydride, 4-ethylbutadecanyl succinic anhydride, 3-ethylbutadecanyl succinic anhydride, 2-ethylbutadecanyl succinic anhydride, 1-ethylbutadecanyl succinic anhydride, 2-butyldodecanyl succinic anhydride, 1-hexyldecanyl succinic anhydride, 1-hexyl-2-decanyl succinic anhydride, 2-hexyldecanyl succinic anhydride, 6,12-dimethylbutadecanyl succinic anhydride, 2,2-diethyldodecanyl succinic anhydride, 4,8,12-trimethyltridecanyl succinic anhydride, 2,2,4,6,8-pentamethylundecanyl succinic anhydride, 2-ethyl-4-methyl-2-(2-methylpentyl)-heptyl succinic anhydride and/or 2-ethyl-4,6-dimethyl-2-propylnonyl succinic anhydride.

Furthermore, it is appreciated that e.g. the term “octadecanyl succinic anhydride” comprises linear and branched octadecanyl succinic anhydride(s). One specific example of linear octadecanyl succinic anhydride(s) is n-octadecanyl succinic anhydride. Specific examples of branched hexadecanyl succinic anhydride(s) are 16-methylheptadecanyl succinic anhydride, 15-methylheptadecanyl succinic anhydride, 14-methylheptadecanyl succinic anhydride, 13-methylheptadecanyl succinic anhydride, 12-methylheptadecanyl succinic anhydride, 11-methylheptadecanyl succinic anhydride, 10-methylheptadecanyl succinic anhydride, 9-methylheptadecanyl succinic anhydride, 8-methylheptadecanyl succinic anhydride, 7-methylheptadecanyl succinic anhydride, 6-methylheptadecanyl succinic anhydride, 5-methylheptadecanyl succinic anhydride, 4-methylheptadecanyl succinic anhydride, 3-methylheptadecanyl succinic anhydride, 2-methylheptadecanyl succinic anhydride, 1-methylheptadecanyl succinic anhydride, 14-ethylhexadecanyl succinic anhydride, 13-ethylhexadecanyl succinic anhydride, 12-ethylhexadecanyl succinic anhydride, 11-ethylhexadecanyl succinic anhydride, 10-ethylhexadecanyl succinic anhydride, 9-ethylhexadecanyl succinic anhydride, 8-ethylhexadecanyl succinic anhydride, 7-ethylhexadecanyl succinic anhydride, 6-ethylhexadecanyl succinic anhydride, 5-ethylhexadecanyl succinic anhydride, 4-ethylhexadecanyl succinic anhydride, 3-ethylhexadecanyl succinic anhydride, 2-ethylhexadecanyl succinic anhydride, 1-ethylhexadecanyl succinic anhydride, 2-hexyldodecanyl succinic anhydride, 2-heptylundecanyl succinic anhydride, iso-octadecanyl succinic anhydride and/or 1-octyl-2-decanyl succinic anhydride.

In one embodiment of the present invention, the at least one alkyl mono-substituted succinic anhydride is selected from the group comprising butylsuccinic anhydride, hexylsuccinic anhydride, heptylsuccinic anhydride, octylsuccinic anhydride, hexadecanyl succinic anhydride, octadecanyl succinic anhydride, and mixtures thereof.

In one embodiment of the present invention, the at least one mono-substituted succinic anhydride is one kind of alkyl mono-substituted succinic anhydride. For example, the one alkyl mono-substituted succinic anhydride is butylsuccinic anhydride. Alternatively, the one alkyl mono-substituted succinic anhydride is hexylsuccinic anhydride. Alternatively, the one alkyl mono-substituted succinic anhydride is heptylsuccinic anhydride or octylsuccinic anhydride. Alternatively, the one alkyl mono-substituted succinic anhydride is hexadecanyl succinic anhydride. For example, the one alkyl mono-substituted succinic anhydride is linear hexadecanyl succinic anhydride such as n-hexadecanyl succinic anhydride or branched hexadecanyl succinic anhydride such as 1-hexyl-2-decanyl succinic anhydride. Alternatively, the one alkyl mono-substituted succinic anhydride is octadecanyl succinic anhydride. For example, the one alkyl mono-substituted succinic anhydride is linear octadecanyl succinic anhydride such as n-octadecanyl succinic anhydride or branched octadecanyl succinic anhydride such as iso-octadecanyl succinic anhydride or 1-octyl-2-decanyl succinic anhydride.

In one embodiment of the present invention, the one alkyl mono-substituted succinic anhydride is butylsuccinic anhydride such as n-butylsuccinic anhydride.

In one embodiment of the present invention, the at least one mono-substituted succinic anhydride is a mixture of two or more kinds of alkyl mono-substituted succinic anhydrides. For example, the at least one mono-substituted succinic anhydride is a mixture of two or three kinds of alkyl mono-substituted succinic anhydrides.

According to another embodiment of the present invention, the surface-treatment agent is at least one polydialkylsiloxane.

Preferred polydialkylsiloxanes are described e.g. in US 2004/0097616 A1. Most preferred are polydialkylsiloxanes selected from the group consisting of polydimethylsiloxane, preferably dimethicone, polydiethylsiloxane and polymethylphenylsiloxane and/or mixtures thereof.

For example, the at least one polydialkylsiloxane is preferably a polydimethylsiloxane (PDMS).

According to another embodiment of the present invention, the surface-treatment agent is at least one cross-linkable compound comprising at least two functional groups, wherein at least one functional group is suitable for cross-linking a polymer resin and wherein at least one functional group is suitable for reacting with the precipitated calcium carbonate.

The term “at least one” cross-linkable compound comprising at least two functional groups in the meaning of the present invention means that the cross-linkable compound comprises, preferably consists of, one or more cross-linkable compound(s) comprising at least two functional groups.

In one embodiment of the present invention, the at least one cross-linkable compound comprising at least two functional groups comprises, preferably consists of, one cross-linkable compound. Alternatively, the at least one cross-linkable compound comprising at least two functional groups comprises, preferably consists of, two or more cross-linkable compounds. For example, the at least one cross-linkable compound comprising at least two functional groups comprises, preferably consists of, two or three cross-linkable compounds.

Preferably, the at least one cross-linkable compound comprising at least two functional groups comprises, more preferably consists of, one cross-linkable compound comprising at least two functional groups.

It is appreciated that the at least one cross-linkable compound comprising at least two functional groups comprises at least one functional group that is suitable for cross-linking a polymer resin.

For the purposes of the present invention, a “cross-linkable compound” is a compound, which comprises functional groups, e.g., carbon multiple bonds, halogen functional groups, sulfur functional groups, or hydrocarbon moieties, and which upon crosslinking is suitable for cross-linking a polymer resin. The inventors surprisingly found out that such a cross-linkable compound can react with the polymer resin, i.e. the polymer precursor, in a crosslinking step, e.g., a chemical crosslinking step. In this way, the polymer resin is (evenly) distributed all over the surface of the precipitated calcium carbonate such that, even if used in small amounts only, the chemical compatibility in the polymer resin and the mechanical properties of the polymer product are improved.

Additionally, the at least one cross-linkable compound comprising at least two functional groups comprises at least one functional group that is suitable for reacting with the precipitated calcium carbonate. For example, the at least one functional group that is suitable for reacting with the precipitated calcium carbonate of the cross-linkable compound comprises one or more terminal triethoxysilyl, trimethoxysilyl and/or organic acid anhydride and/or salts thereof and/or carboxylic acid group(s) and/or salts thereof. Preferably, the at least one functional group that is suitable for reacting with the precipitated calcium carbonate of the cross-linkable compound comprises one or more terminal triethoxysilyl, trimethoxysilyl or organic acid anhydride and/or salts thereof or carboxylic acid group(s) and/or salts thereof.

In a preferred embodiment, the at least one functional group that is suitable for reacting with the precipitated calcium carbonate of the cross-linkable compound comprises one or more organic acid anhydride and/or salts thereof or carboxylic acid group(s) and/or salts thereof. Most preferably, the at least one functional group that is suitable for reacting with the precipitated calcium carbonate of the cross-linkable compound comprises one or more organic acid anhydride group(s) and/or salts thereof. Alternatively, the at least one functional group that is suitable for reacting with the precipitated calcium carbonate of the cross-linkable compound comprises one or more triethoxysilyl or trimethoxysilyl functional group(s) and/or salts thereof.

Preferably, the one or more organic acid anhydride group(s) is/are one or more succinic anhydride group(s) obtained by grafting maleic anhydride onto a homo- or copolymer.

In view of this, the at least one functional group that is suitable for reacting with the precipitated calcium carbonate of the cross-linkable compound preferably comprises, more preferably consists of, one or more succinic anhydride group(s) obtained by grafting maleic anhydride onto a homo- or copolymer. For example, the at least one functional group that is suitable for reacting with the precipitated calcium carbonate of the cross-linkable compound preferably comprises, more preferably consists of, one succinic anhydride group obtained by grafting maleic anhydride onto a homo- or copolymer. Alternatively, the at least one functional group that is suitable for reacting with the precipitated calcium carbonate of the cross-linkable compound preferably comprises, more preferably consists of, two or more succinic anhydride groups obtained by grafting maleic anhydride onto a homo- or copolymer, e.g. from 2 to 12, particularly from 2 to 9 such as from 2 to 6, succinic anhydride groups. Alternatively, the at least one functional group that is suitable for reacting with the precipitated calcium carbonate of the cross-linkable compound preferably comprises, more preferably consists of, one triethoxysilyl or trimethoxysilyl functional group. For example, the at least one functional group that is suitable for reacting with the precipitated calcium carbonate of the cross-linkable compound preferably comprises, more preferably consists of, two or more triethoxysilyl or trimethoxysilyl functional groups, e.g. from 2 to 12, particularly from 2 to 9 such as from 2 to 6, triethoxysilyl or trimethoxysilyl functional groups.

It is appreciated that the at least one functional group that is suitable for reacting with the precipitated calcium carbonate of the cross-linkable compound may be present as salt, preferably in the form of the sodium or potassium salt.

In view of the foregoing, the at least one cross-linkable compound comprising at least two functional groups may comprise two or more functional groups, e.g. one or more functional group(s) that is/are suitable for cross-linking a polymer resin and one or more functional group(s) that is/are suitable for reacting with the precipitated calcium carbonate.

In a preferred embodiment, the at least one cross-linkable compound comprising at least two functional groups preferably comprises two functional groups, e.g. one functional group that is suitable for cross-linking a polymer resin and one functional group that is suitable for reacting with the precipitated calcium carbonate.

It is appreciated that the number of functional groups in the at least one cross-linkable compound refers to the number of different functional groups, i.e. functional groups not having the same chemical structure. That is to say, if the at least one cross-linkable compound comprises e.g. two functional groups, the two functional groups are of different chemical structures, whereas each of the two different functional groups may be present one or more times.

According to one embodiment, the at least one cross-linkable compound comprising at least two functional groups is at least one grafted polymer comprising at least one succinic anhydride group obtained by grafting maleic anhydride onto a homo- or copolymer comprising butadiene units and optionally styrene units.

The term “grafted” or “maleic anhydride grafted” means that a succinic anhydride is obtained after reaction of substituent(s) R1 and/or R2 comprising a carbon-carbon double bond with the double bond of maleic anhydride. Thus, the terms “grafted homopolymer” and “grafted copolymer” refer to a corresponding homopolymer and copolymer each bearing succinic anhydride moieties formed from the reaction of a carbon-carbon double bond with the double bond of maleic anhydride, respectively. It is appreciated the at least one grafted polymer or maleic anhydride grafted polymer may be also referred to as “polymer, e.g. polybutadiene, functionalized with maleic anhydride” or “polymer, e.g. polybutadiene, adducted maleic anhydride”.

That is to say, the at least one cross-linkable compound comprising at least two functional groups is preferably a grafted polybutadiene homopolymer comprising at least one succinic anhydride group obtained by grafting maleic anhydride onto a polybutadiene homopolymer or a grafted polybutadiene-styrene copolymer comprising at least one succinic anhydride group obtained by grafting maleic anhydride onto a polybutadiene-styrene copolymer. More preferably, the at least one cross-linkable compound comprising at least two functional groups is a grafted polybutadiene homopolymer comprising at least one succinic anhydride group obtained by grafting maleic anhydride onto a polybutadiene homopolymer.

According to an alternative embodiment, the at least one cross-linkable compound comprising at least two functional groups is a sulfur-containing trialkoxysilane, preferably a compound comprising two trialkoxysilyl alkyl groups linked with a polysulfide.

If the at least one cross-linkable compound comprising at least two functional groups is a grafted polybutadiene homopolymer comprising at least one succinic anhydride group obtained by grafting maleic anhydride onto a polybutadiene homopolymer, the grafted polybutadiene homopolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of functional groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800.

In one embodiment, the grafted polybutadiene homopolymer comprising at least one succinic anhydride group obtained by grafting maleic anhydride onto a polybutadiene homopolymer preferably has
i) a number average molecular weight Mn measured by gel permeation chromatography from 1 000 to 20 000 g/mol, preferably from 1 400 to 15 000 g/mol, and more preferably from 2 000 to 000 g/mol measured according to EN ISO 16014-1:2019, or
ii) a number of functional groups per chain in the range from 2 to 12, preferably from 2 to 9, and more preferably from 2 to 6, or
iii) an anhydride equivalent weight in the range from 400 to 2 200, preferably from 500 to 2 000, and more preferably from 550 to 1 800.

In a preferred embodiment, the grafted polybutadiene homopolymer comprising at least one succinic anhydride group obtained by grafting maleic anhydride onto a polybutadiene homopolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
ii) a number of functional groups per chain in the range from 2 to 12, preferably from 2 to 9, and more preferably from 2 to 6, and
ii) an anhydride equivalent weight in the range from 400 to 2 200, preferably from 500 to 2 000, and more preferably from 550 to 1 800.

Additionally or alternatively, the grafted polybutadiene homopolymer comprising at least one succinic anhydride group obtained by grafting maleic anhydride onto a polybutadiene homopolymer has an acid number in the range from 10 to 300 meq KOH per g of grafted polybutadiene homopolymer, preferably 20 to 200 meq KOH/g, more preferably 30 to 150 meq KOH/g, measured according to ASTM D974-14.

In one embodiment, the grafted polybutadiene homopolymer comprising at least one succinic anhydride group obtained by grafting maleic anhydride onto a polybutadiene homopolymer thus has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
ii) a number of functional groups per chain in the range from 2 to 12, preferably from 2 to 9, and more preferably from 2 to 6, and
iii) an anhydride equivalent weight in the range from 400 to 2 200, preferably from 500 to 2 000, and more preferably from 550 to 1 800, and
iv) an acid number in the range from 10 to 300 meq KOH per g of grafted polybutadiene homopolymer, preferably 20 to 200 meq KOH/g, more preferably 30 to 150 meq KOH/g, measured according to ASTM D974-14.

Additionally or alternatively, the grafted polybutadiene homopolymer comprising at least one succinic anhydride group obtained by grafting maleic anhydride onto a polybutadiene homopolymer has a Brookfield viscosity at 25° C. in the range from 3 000 to 70 000 cPs, preferably in the range from 5 000 to 50 000 cPs. Alternatively, the maleic anhydride grafted polybutadiene homopolymer has a Brookfield viscosity at 55° C. in the range from 100 000 to 170 000 cPs, preferably in the range from 120 000 to 160 000 cPs.

In one embodiment, the grafted polybutadiene homopolymer comprising at least one succinic anhydride group obtained by grafting maleic anhydride onto a polybutadiene homopolymer thus has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
ii) a number of functional groups per chain in the range from 2 to 12, preferably from 2 to 9, and more preferably from 2 to 6, and
iii) an anhydride equivalent weight in the range from 400 to 2 200, preferably from 500 to 2 000, and more preferably from 550 to 1 800, and
iv) an acid number in the range from 10 to 300 meq KOH per g of grafted polybutadiene homopolymer, preferably 20 to 200 meq KOH/g, more preferably 30 to 150 meq KOH/g, measured according to ASTM D974-14, and
v) a Brookfield viscosity at 25° C. in the range from 3 000 to 70 000 cPs, preferably in the range from 5 000 to 50 000 cPs.

For example, the grafted polybutadiene homopolymer comprising at least one succinic anhydride group obtained by grafting maleic anhydride onto a polybutadiene homopolymer may have a number average molecular weight Mn measured by gel permeation chromatography from 1 000 to 20 000 g/mol, preferably from 1 400 to 15 000 g/mol, more preferably from 2 000 to 10 000 g/mol, an acid number in the range from 20 to 200 meq KOH per g of grafted polybutadiene homopolymer, preferably 30 to 150 meq KOH/g, measured according to ASTM D974-14. In another embodiment, the grafted polybutadiene homopolymer comprising at least one succinic anhydride group obtained by grafting maleic anhydride onto a polybutadiene homopolymer may have a number average molecular weight Mn measured by gel permeation chromatography from 2000 to 5000 g/mol, an acid number in the range from 30 to 100 meq KOH/g, measured according to ASTM D974-14.

In one embodiment, the grafted polybutadiene homopolymer comprising at least one succinic anhydride group obtained by grafting maleic anhydride onto a polybutadiene homopolymer has a number average molecular weight Mn measured by gel permeation chromatography from 2 000 to 10 000 g/mol, preferably from 2 000 to 4 500 g/mol or from 4 500 to 7 000 g/mol, a number of functional groups per chain in the range from 2 to 6, preferably from 2 to 4 or from 4 to 6, an anhydride equivalent weight in the range from 550 to 1 800, preferably from 550 to 1 000 or from 1 000 to 1 800, and a Brookfield viscosity at 25° C. in the range from 5 000 to 50 000 cPs, preferably from 5 000 to 10 000 cPs or from 35 000 to 50 000 cPs.

For example, the grafted polybutadiene homopolymer comprising at least one succinic anhydride group obtained by grafting maleic anhydride onto a polybutadiene homopolymer has a number average molecular weight Mn measured by gel permeation chromatography from 2 000 to 4 500 g/mol, a number of functional groups per chain in the range from 2 to 4, an anhydride equivalent weight in the range from 1 000 to 1 800, and a Brookfield viscosity at 25° C. in the range from 5 000 to 10 000 cPs. In an alternative embodiment, the grafted polybutadiene homopolymer comprising at least one succinic anhydride group obtained by grafting maleic anhydride onto a polybutadiene homopolymer has a number average molecular weight Mn measured by gel permeation chromatography from 4 500 to 7 000 g/mol, a number of functional groups per chain in the range from 4 to 6, an anhydride equivalent weight in the range from 550 to 1 000, and a Brookfield viscosity at 25° C. in the range from 35 000 to 50 000 cPs. In an alternative embodiment, the grafted polybutadiene homopolymer comprising at least one succinic anhydride group obtained by grafting maleic anhydride onto a polybutadiene homopolymer has a number average molecular weight Mn measured by gel permeation chromatography from 2 500 to 4 500 g/mol, a number of functional groups per chain in the range from 2 to 4, an anhydride equivalent weight in the range from 550 to 1 000, and a Brookfield viscosity at 55° C. in the range from 120 000 to 160 000 cPs.

Additionally or alternatively, the at least one cross-linkable compound comprising at least two functional groups is a grafted polybutadiene-styrene copolymer comprising at least one succinic anhydride group obtained by grafting maleic anhydride onto a polybutadiene-styrene copolymer and having
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of functional groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) a 1,2 vinyl content from 20 to 80 mol.-%, preferably from 20 to 40 mol.-%, based on the total weight of the grafted polybutadiene-styrene copolymer.

In one embodiment, the grafted polybutadiene-styrene copolymer comprising at least one succinic anhydride group obtained by grafting maleic anhydride onto a polybutadiene-styrene copolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, or
ii) a number of functional groups per chain in the range from 2 to 12, preferably from 2 to 9, and more preferably from 2 to 6, or
ii) an anhydride equivalent weight in the range from 400 to 2 200, preferably from 500 to 2 000, and more preferably from 550 to 1 800, or
iv) a 1,2 vinyl content from 20 to 80 mol.-%, preferably from 20 to 40 mol.-%, based on the total weight of the grafted polybutadiene-styrene copolymer.

In a preferred embodiment, the grafted polybutadiene-styrene copolymer comprising at least one succinic anhydride group obtained by grafting maleic anhydride onto a polybutadiene-styrene copolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
ii) a number of functional groups per chain in the range from 2 to 12, preferably from 2 to 9, and more preferably from 2 to 6, and
iii) an anhydride equivalent weight in the range from 400 to 2 200, preferably from 500 to 2 000, and more preferably from 550 to 1 800, and
iv) a 1,2 vinyl content from 20 to 80 mol.-%, preferably from 20 to 40 mol.-%, based on the total weight of the grafted polybutadiene-styrene copolymer.

Additionally or alternatively, the grafted polybutadiene-styrene copolymer comprising at least one succinic anhydride group obtained by grafting maleic anhydride onto a polybutadiene-styrene copolymer has a Brookfield viscosity at 45° C. in the range from 100 000 to 200 000 cPs, preferably in the range from 150 000 to 200 000 cPs.

In one embodiment, the grafted polybutadiene-styrene copolymer comprising at least one succinic anhydride group obtained by grafting maleic anhydride onto a polybutadiene-styrene copolymer has a number average molecular weight Mn measured by gel permeation chromatography from 2 000 to 10 000 g/mol, a number of functional groups per chain in the range from 2 to 6, an anhydride equivalent weight in the range from 550 to 1 800, and a Brookfield viscosity at 45° C. in the range from 150 000 to 200 000 cPs.

According to yet another embodiment of the present invention, the at least one cross-linkable compound is a sulfur-containing trialkoxysilane.

In one embodiment, the sulfur-containing trialkoxysilane is preferably selected from the group comprising, preferably consisting of, mercaptopropyltrimethoxysilane (MPTS), mercaptopropyltriethoxysilane, bis(triethoxysilylpropyl) disulfide (TESPD), bis(triethoxysilylpropyl) tetrasulfide (TESPT), 3-aminopropyltrimethoxysilane (APTMS), 3-aminopropyltriethoxysilane, and mixtures thereof.

In one embodiment, the sulfur-containing trialkoxysilane is preferably a compound comprising two trialkoxysilyl alkyl groups linked with a polysulfide. For example, the compound comprising two trialkoxysilyl alkyl groups linked with a polysulfide is selected from bis(triethoxysilylpropyl) disulfide (TESPD), bis(triethoxysilylpropyl) tetrasulfide (TESPT) and mixtures thereof. Preferably, the compound comprising two trialkoxysilyl alkyl groups linked with a polysulfide is bis(triethoxysilylpropyl) tetrasulfide (TESPT).

According to another embodiment of the present invention, the surface-treatment agent is at least one grafted polymer comprising at least one succinic anhydride group obtained by grafting maleic anhydride onto a homo- or copolymer comprising butadiene units and optionally styrene units and/or salts or reaction products thereof.

It is appreciated that the “at least one grafted polymer” comprises, preferably consists of, one or more grafted polymer(s). For example, the “at least one grafted polymer” comprises, preferably consists of, one grafted polymer. Alternatively, the “at least one grafted polymer” comprises, preferably consists of, two or more, preferably two, grafted polymers.

Preferably, the “at least one grafted polymer” comprises, preferably consists of, one grafted polymer comprising at least one succinic anhydride group obtained by grafting maleic anhydride onto a homo- or copolymer comprising butadiene units and optionally styrene units and/or salts or reaction products thereof.

It is appreciated that the at least one grafted polymer comprises at least one succinic anhydride group obtained by grafting maleic anhydride onto a homo- or copolymer comprising butadiene units and optionally styrene units and/or salts or reaction products thereof. The term “at least one” succinic anhydride group obtained by grafting maleic anhydride onto a homo- or copolymer comprising butadiene units and optionally styrene units and/or salts or reaction products thereof in the meaning of the present invention means that the grafted polymer comprises, preferably consists of, one or more succinic anhydride group(s) obtained by grafting maleic anhydride onto a homo- or copolymer comprising butadiene units and optionally styrene units and/or salts or reaction products thereof.

In view of this, the at least one grafted polymer preferably comprises one or more succinic anhydride group(s) obtained by grafting maleic anhydride onto a homo- or copolymer. For example, the at least one grafted polymer comprises one succinic anhydride group obtained by grafting maleic anhydride onto a homo- or copolymer. Alternatively, the at least one grafted polymer comprises two or more succinic anhydride groups obtained by grafting maleic anhydride onto a homo- or copolymer, e.g. from 2 to 12, particularly from 2 to 9 such as from 2 to 6, succinic anhydride groups.

The term “grafted” or “maleic anhydride grafted” means that a succinic anhydride is obtained after reaction of substituent(s) R1 and/or R2 comprising a carbon-carbon double bond with the double bond of maleic anhydride. Thus, the terms “grafted homopolymer” and “grafted copolymer” refer to a corresponding homopolymer and copolymer each bearing succinic anhydride moieties formed from the reaction of a carbon-carbon double bond with the double bond of maleic anhydride, respectively. It is appreciated the at least one grafted polymer or maleic anhydride grafted polymer may be also referred to as “polymer, e.g. polybutadiene, functionalized with maleic anhydride” or “polymer, e.g. polybutadiene, adducted maleic anhydride”.

It is appreciated that the at least one succinic anhydride group may be present as salt, preferably in the form of the sodium or potassium salt.

Preferably, the one or more succinic anhydride group(s) of the at least one grafted polymer is/are suitable for reacting with the calcium carbonate-comprising material.

According to one embodiment, the at least one grafted polymer comprises at least one unsubstituted succinic anhydride group obtained by grafting maleic anhydride onto a homo- or copolymer comprising butadiene units and/or salts or reaction products thereof and optionally styrene units. The term “unsubstituted” succinic anhydride group obtained by grafting maleic anhydride onto a homo- or copolymer comprising butadiene units and/or salts or reaction products thereof and optionally styrene units means that the succinic anhydride group comprises only substituents which are linked to the homo- or copolymer backbone. In other words, the succinic anhydride group is free of substituents which are not linked to the homo- or copolymer backbone.

That is to say, the at least one grafted polymer is preferably a grafted polybutadiene homopolymer comprising at least one succinic anhydride group obtained by grafting maleic anhydride onto a polybutadiene homopolymer or a grafted polybutadiene-styrene copolymer comprising at least one succinic anhydride group obtained by grafting maleic anhydride onto a polybutadiene-styrene copolymer. For example, the at least one grafted polymer is preferably a grafted polybutadiene homopolymer comprising at least one unsubstituted succinic anhydride group obtained by grafting maleic anhydride onto a polybutadiene homopolymer or a grafted polybutadiene-styrene copolymer comprising at least one unsubstituted succinic anhydride group obtained by grafting maleic anhydride onto a polybutadiene-styrene copolymer. More preferably, the at least one grafted polymer is a grafted polybutadiene homopolymer comprising at least one succinic anhydride group obtained by grafting maleic anhydride onto a polybutadiene homopolymer. For example, the at least one grafted polymer is preferably a grafted polybutadiene homopolymer comprising at least one unsubstituted succinic anhydride group obtained by grafting maleic anhydride onto a polybutadiene homopolymer.

If the at least one grafted polymer is a grafted polybutadiene homopolymer comprising at least one (preferably unsubstituted) succinic anhydride group obtained by grafting maleic anhydride onto a polybutadiene homopolymer, the grafted polybutadiene homopolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of functional groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800.

In one embodiment, the grafted polybutadiene homopolymer comprising at least one (preferably unsubstituted) succinic anhydride group obtained by grafting maleic anhydride onto a polybutadiene homopolymer preferably has
iv) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, or
v) a number of functional groups per chain in the range from 2 to 12, preferably from 2 to 9, and more preferably from 2 to 6, or
vi) an anhydride equivalent weight in the range from 400 to 2 200, preferably from 500 to 2 000, and more preferably from 550 to 1 800.

In a preferred embodiment, the grafted polybutadiene homopolymer comprising at least one (preferably unsubstituted) succinic anhydride group obtained by grafting maleic anhydride onto a polybutadiene homopolymer preferably has
iv) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
v) a number of functional groups per chain in the range from 2 to 12, preferably from 2 to 9, and more preferably from 2 to 6, and
vi) an anhydride equivalent weight in the range from 400 to 2 200, preferably from 500 to 2 000, and more preferably from 550 to 1 800.

Additionally or alternatively, the grafted polybutadiene homopolymer comprising at least one succinic anhydride group obtained by grafting maleic anhydride onto a polybutadiene homopolymer has an acid number in the range from 10 to 300 meq KOH per g of grafted polybutadiene homopolymer, preferably 20 to 200 meq KOH/g, more preferably 30 to 150 meq KOH/g, measured according to ASTM D974-14.

In one embodiment, the grafted polybutadiene homopolymer comprising at least one (preferably unsubstituted) succinic anhydride group obtained by grafting maleic anhydride onto a polybutadiene homopolymer thus has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
ii) a number of functional groups per chain in the range from 2 to 12, preferably from 2 to 9, and more preferably from 2 to 6, and
iii) an anhydride equivalent weight in the range from 400 to 2 200, preferably from 500 to 2 000, and more preferably from 550 to 1 800, and
iv) an acid number in the range from 10 to 300 meq KOH per g of grafted polybutadiene homopolymer, preferably 20 to 200 meq KOH/g, more preferably 30 to 150 meq KOH/g, measured according to ASTM D974-14.

Additionally or alternatively, the grafted polybutadiene homopolymer comprising at least one (preferably unsubstituted) succinic anhydride group obtained by grafting maleic anhydride onto a polybutadiene homopolymer has a Brookfield viscosity at 25° C. in the range from 3 000 to 70 000 cPs, preferably in the range from 5 000 to 50 000 cPs. Alternatively, the grafted polybutadiene homopolymer comprising at least one (preferably unsubstituted) succinic anhydride group obtained by grafting maleic anhydride onto a polybutadiene homopolymer has a Brookfield viscosity at 55° C. in the range from 100 000 to 170 000 cPs, preferably in the range from 120 000 to 160 000 cPs.

In one embodiment, the grafted polybutadiene homopolymer comprising at least one (preferably unsubstituted) succinic anhydride group obtained by grafting maleic anhydride onto a polybutadiene homopolymer thus has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and a number of functional groups per chain in the range from 2 to 12, preferably from 2 to 9, and more preferably from 2 to 6, and
iii) an anhydride equivalent weight in the range from 400 to 2 200, preferably from 500 to 2 000, and more preferably from 550 to 1 800, and
iv) an acid number in the range from 10 to 300 meq KOH per g of grafted polybutadiene homopolymer, preferably 20 to 200 meq KOH/g, more preferably 30 to 150 meq KOH/g, measured according to ASTM D974-14, and
v) a Brookfield viscosity at 25° C. in the range from 3 000 to 70 000 cPs, preferably in the range from 5 000 to 50 000 cPs.

The term “grafted” means that a succinic anhydride group is obtained obtained after reaction of substituent(s) R1 and/or R2 comprising a carbon-carbon double bond with the double bond of maleic anhydride.

For example, the grafted polybutadiene homopolymer comprising at least one (preferably unsubstituted) succinic anhydride group obtained by grafting maleic anhydride onto a polybutadiene homopolymer may have a number average molecular weight Mn measured by gel permeation chromatography from 1 000 to 20 000 g/mol, preferably from 1 400 to 15 000 g/mol, more preferably from 2 000 to 10 000 g/mol, an acid number in the range from 20 to 200 meq KOH per g of grafted polybutadiene homopolymer, preferably 30 to 150 meq KOH/g, measured according to ASTM D974-14. In another embodiment, the grafted polybutadiene homopolymer comprising at least one (preferably unsubstituted) succinic anhydride group obtained by grafting maleic anhydride onto a polybutadiene homopolymer may have a number average molecular weight Mn measured by gel permeation chromatography from 2000 to 5000 g/mol, an acid number in the range from 30 to 100 meq KOH/g, measured according to ASTM D974-14.

In one embodiment, the grafted polybutadiene homopolymer comprising at least one (preferably unsubstituted) succinic anhydride group obtained by grafting maleic anhydride onto a polybutadiene homopolymer has a number average molecular weight Mn measured by gel permeation chromatography from 2 000 to 10 000 g/mol, preferably from 2 000 to 4 500 g/mol or from 4 500 to 7 000 g/mol, a number of functional groups per chain in the range from 2 to 6, preferably from 2 to 4 or from 4 to 6, an anhydride equivalent weight in the range from 550 to 1 800, preferably from 550 to 1 000 or from 1 000 to 1 800, and a Brookfield viscosity at 25° C. in the range from 5 000 to 50 000 cPs, preferably from 5 000 to 10 000 cPs or from 35 000 to 50 000 cPs.

For example, the grafted polybutadiene homopolymer comprising at least one (preferably unsubstituted) succinic anhydride group obtained by grafting maleic anhydride onto a polybutadiene homopolymer has a number average molecular weight Mn measured by gel permeation chromatography from 2 000 to 4 500 g/mol, a number of functional groups per chain in the range from 2 to 4, an anhydride equivalent weight in the range from 1 000 to 1 800, and a Brookfield viscosity at 25° C. in the range from 5 000 to 10 000 cPs. In an alternative embodiment, the grafted polybutadiene homopolymer comprising at least one (preferably unsubstituted) succinic anhydride group obtained by grafting maleic anhydride onto a polybutadiene homopolymer has a number average molecular weight Mn measured by gel permeation chromatography from 4 500 to 7 000 g/mol, a number of functional groups per chain in the range from 4 to 6, an anhydride equivalent weight in the range from 550 to 1 000, and a Brookfield viscosity at 25° C. in the range from 35 000 to 50 000 cPs. In an alternative embodiment, the grafted polybutadiene homopolymer comprising at least one (preferably unsubstituted) succinic anhydride group obtained by grafting maleic anhydride onto a polybutadiene homopolymer has a number average molecular weight Mn measured by gel permeation chromatography from 2 500 to 4 500 g/mol, a number of functional groups per chain in the range from 2 to 4, an anhydride equivalent weight in the range from 550 to 1 000, and a Brookfield viscosity at 55° C. in the range from 120 000 to 160 000 cPs.

Additionally or alternatively, the at least one grafted polymer is a grafted polybutadiene-styrene copolymer comprising at least one (preferably unsubstituted) succinic anhydride group obtained by grafting maleic anhydride onto a polybutadiene-styrene copolymer and having
i) a number average molecular weight Mn measured by gel permeation chromatography from 1 000 to 20 000 g/mol, preferably from 1 400 to 15 000 g/mol, and more preferably from 2 000 to 000 g/mol measured according to EN ISO 16014-1:2019, and/or
ii) a number of functional groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) a 1,2 vinyl content from 20 to 80 mol.-%, preferably from 20 to 40 mol.-%, based on the total weight of the grafted polybutadiene-styrene copolymer.

In one embodiment, the grafted polybutadiene-styrene copolymer comprising at least one (preferably unsubstituted) succinic anhydride group obtained by grafting maleic anhydride onto a polybutadiene-styrene copolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, or
ii) a number of functional groups per chain in the range from 2 to 12, preferably from 2 to 9, and more preferably from 2 to 6, or
iii) an anhydride equivalent weight in the range from 400 to 2 200, preferably from 500 to 2 000, and more preferably from 550 to 1 800, or
iv) a 1,2 vinyl content from 20 to 80 mol.-%, preferably from 20 to 40 mol.-%, based on the total weight of the grafted polybutadiene-styrene copolymer.

In a preferred embodiment, the grafted polybutadiene-styrene copolymer comprising at least one (preferably unsubstituted) succinic anhydride group obtained by grafting maleic anhydride onto a polybutadiene-styrene copolymer preferably has
i) a number average molecular weight Mn measured by gel permeation chromatography from 1 000 to 20 000 g/mol, preferably from 1 400 to 15 000 g/mol, and more preferably from 2 000 to 10 000 g/mol measured according to EN ISO 16014-1:2019, and
ii) a number of functional groups per chain in the range from 2 to 12, preferably from 2 to 9, and more preferably from 2 to 6, and
iii) an anhydride equivalent weight in the range from 400 to 2 200, preferably from 500 to 2 000, and more preferably from 550 to 1 800, and
iv) a 1,2 vinyl content from 20 to 80 mol.-%, preferably from 20 to 40 mol.-%, based on the total weight of the grafted polybutadiene-styrene copolymer.

Additionally or alternatively, the (grafted polybutadiene-styrene copolymer comprising at least one (preferably unsubstituted) succinic anhydride group obtained by grafting maleic anhydride onto a polybutadiene-styrene copolymer has a Brookfield viscosity at 45° C. in the range from 100 000 to 200 000 cPs, preferably in the range from 150 000 to 200 000 cPs.

In one embodiment, the grafted polybutadiene-styrene copolymer comprising at least one (preferably unsubstituted) succinic anhydride group obtained by grafting maleic anhydride onto a polybutadiene-styrene copolymer has a number average molecular weight Mn measured by gel permeation chromatography from 2 000 to 10 000 g/mol, a number of functional groups per chain in the range from 2 to 6, an anhydride equivalent weight in the range from 550 to 1 800, and a Brookfield viscosity at 45° C. in the range from 150 000 to 200 000 cPs.

It is appreciated that the treatment layer preferably comprises a surface-treatment agent selected from at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof.

The treated precipitated calcium carbonate is preferably formed in that the precipitated calcium carbonate is contacted with the surface-treatment agent such that a treatment layer comprising the surface-treatment agent and/or salts or reaction products thereof is/are formed on the surface of the precipitated calcium carbonate.

The term “reaction products” of the surface-treatment agent refers to products obtained by contacting the precipitated calcium carbonate with the surface-treatment agent. Said reaction products are formed between at least a part of the applied surface-treatment agent and reactive molecules located at the surface of the precipitated calcium carbonate. Thus, the reaction products include salts of the surface-treatment agent and/or other reaction products such as hydrolysis products and/or their salts.

The treated precipitated calcium carbonate preferably comprises the treatment layer in an amount ranging from 0.1 to 3 wt.-%, preferably from 0.1 to 1.2 wt.-% based on the total weight of the treated precipitated calcium carbonate, and/or in an amount ranging from 0.2 to 5.0 mg/m² of the BET specific surface area of the precipitated calcium carbonate and preferably from 0.5 to 3.0 mg/m² of the BET specific surface area of the precipitated calcium carbonate.

It is to be noted that the treated precipitated calcium carbonate typically has a residual total moisture content that is below the residual total moisture content of the (untreated) precipitated calcium carbonate.

Thus, the treated precipitated calcium carbonate preferably has a residual total moisture content of ≤0.3 wt.-%, preferably of ≤0.2 wt.-%, and most preferably of ≤0.1 wt.-%, based on the total dry weight of the treated precipitated calcium carbonate.

Additionally or alternatively, the treated precipitated calcium carbonate preferably has a moisture pick-up susceptibility of ≤6 mg/g, preferably ≤3 mg/g, more preferably ≤2 mg/g, and most preferably ≤1 mg/g, e.g. ≤0.8 mg/g, based on the total dry weight of the treated precipitated calcium carbonate.

In one embodiment, the treated precipitated calcium carbonate preferably has
a residual total moisture content of ≤0.3 wt.-%, preferably of ≤0.2 wt.-%, and most preferably of ≤0.1 wt.-%, based on the total dry weight of the treated precipitated calcium carbonate, or
a moisture pick-up susceptibility of ≤6 mg/g, preferably ≤3 mg/g, more preferably ≤2 mg/g, and most preferably ≤1 mg/g, e.g. ≤0.8 mg/g, based on the total dry weight of the treated precipitated calcium carbonate.

Alternatively, the treated precipitated calcium carbonate preferably has
a residual total moisture content of ≤0.3 wt.-%, preferably of ≤0.2 wt.-%, and most preferably of ≤0.1 wt.-%, based on the total dry weight of the treated precipitated calcium carbonate, and
a moisture pick-up susceptibility of ≤6 mg/g, preferably ≤3 mg/g, more preferably ≤2 mg/g, and most preferably ≤1 mg/g, e.g. ≤0.8 mg/g, based on the total dry weight of the treated precipitated calcium carbonate.

Thus, the treated precipitated calcium carbonate has
a weight median particle size d₅₀ of ≤60 μm, preferably ≤20 μm, more preferably ≤6 μm, even more preferably ≤3 μm, and most preferably ≤2 μm, and
a top cut particle size d₉₈ of ≤500 μm, preferably ≤200 μm, more preferably ≤20 μm, even more preferably ≤10 μm, and most preferably ≤8 μm, and
a residual total moisture content of ≤0.3 wt.-%, more preferably ≤0.2 wt.-% and most preferably ≤0.1 wt.-%, based on the total dry weight of the precipitated calcium carbonate, and
a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate.

In one embodiment, the treated precipitated calcium carbonate has
a weight median particle size d₅₀ of ≤60 μm, preferably ≤20 μm, more preferably ≤6 μm, even more preferably ≤3 μm, and most preferably ≤2 μm, and
a top cut particle size d₉₈ of ≤500 μm, preferably ≤200 μm, more preferably ≤20 μm, even more preferably ≤10 μm, and most preferably ≤8 μm, and
a residual total moisture content of ≤0.3 wt.-%, more preferably ≤0.2 wt.-% and most preferably ≤0.1 wt.-%, based on the total dry weight of the precipitated calcium carbonate, and
a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate, and
a moisture pick-up susceptibility of ≤6 mg/g, preferably ≤3 mg/g, more preferably ≤2 mg/g, and most preferably ≤1 mg/g, e.g. ≤0.8 mg/g, based on the total dry weight of the treated precipitated calcium carbonate.

In another embodiment, the treated precipitated calcium carbonate has
a weight median particle size d₅₀ of ≤60 μm, preferably ≤20 μm, more preferably ≤6 μm, even more preferably ≤3 μm, and most preferably ≤2 μm, and
a top cut particle size d₉₈ of ≤500 μm, preferably ≤200 μm, more preferably ≤20 μm, even more preferably ≤10 μm, and most preferably ≤8 μm, and
a residual total moisture content of ≤0.3 wt.-%, more preferably ≤0.2 wt.-% and most preferably ≤0.1 wt.-%, based on the total dry weight of the precipitated calcium carbonate, and
a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the precipitated calcium carbonate, and
a moisture pick-up susceptibility of ≤6 mg/g, preferably ≤3 mg/g, more preferably ≤2 mg/g, and most preferably ≤1 mg/g, e.g. ≤0.8 mg/g, based on the total dry weight of the treated precipitated calcium carbonate, and
a specific surface area (BET) in the range from 1 to 50 m²/g, preferably 2.5 to 15 m²/g, and most preferably from 3 to 9 m²/g, as measured using nitrogen and the BET method according to ISO 9277.

### Process for the Preparation of the Precipitated Calcium Carbonate

According to one aspect of the present invention, the precipitated calcium carbonate of the present invention is obtainable by a process comprising the steps of:
a) providing a precipitated calcium carbonate having a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the material, and
b) grinding the precipitated calcium carbonate of step a) to
   a weight median particle size d₆₀ of ≤60 μm, preferably ≤20 μm, more preferably ≤6 μm, even more preferably ≤3 μm, and most preferably of ≤2 μm,
   a top cut particle size d₉₈ of ≤500 μm, preferably ≤200 μm, more preferably ≤20 μm, even more preferably ≤10 μm, and most preferably ≤8 μm.

It is preferred that the precipitated calcium carbonate is obtained from water decarbonisation and/or water softening.

According to one embodiment, the calcium carbonate-comprising material provided in step a) has a weight median particle size d₅₀ ranging from 200 μm to 3.0 mm, preferably from 300 μm to 1.6 mm, more preferably from 500 μm to 1.4 mm, and most preferably from 800 μm to 1.2 mm. It is preferred that the precipitated calcium carbonate provided in step a) is in the form of spherical shaped beads. It is appreciated that such spherical shaped beads are preferably obtained from water decarbonization and/or water softening by precipitated and crystal growth to the respective particle size. As the precipitated calcium carbonate provided in step a) is obtained from water decarbonization and/or water softening, the precipitated calcium carbonate of step a) can contain up to 5 wt.-%, based on the total weight of the precipitated calcium carbonate, of quartz and/or ground natural calcium carbonate such as chalk, limestone and/or marble. For example, the precipitated calcium carbonate of step a) can contain up to 5 wt.-%, based on the total weight of the precipitated calcium carbonate, of either quartz or ground natural calcium carbonate such as chalk, limestone and/or marble.

It is appreciated that grinding step b) can be carried out by any grinding means known in the art. In general, the grinding step can be carried out with any conventional grinding device, for example, under conditions such that refinement predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. Furthermore, grinding step b) can be carried out by dry grinding or wet grinding.

It is preferred that grinding step b) is carried out by wet grinding. Thus, the precipitated calcium carbonate of step a) is preferably provided in form of an aqueous suspension.

The aqueous suspension subjected to step b) may have any solids content that is suitable to be subjected to a wet grinding. However, in order to obtain the inventive precipitated calcium carbonate it is specifically advantageous that the aqueous suspension subjected to step b) has a relatively low solids content. Thus, it is preferred that the aqueous suspension subjected to step b) has a solids content in the range from 1 to 30 wt.-%, preferably from 2 to 25 wt.-%, based on the total weight of the aqueous suspension.

The term “wet grinding” in the meaning of the process according to the present invention refers to the comminution (e.g., in a ball mill, semi-autogenous mill, or autogenous mill) of solid material (e.g., of mineral origin) in the presence of water meaning that said material is in form of an aqueous slurry or suspension.

For the purposes of the present invention, any suitable mill known in the art may be used. However, said wet grinding step is preferably carried out in a ball mill. It has to be noted that step b) is carried out in at least one wet grinding step, i.e. it is also possible to use a series of grinding units which may, for example, be selected from ball mills, semi-autogenous mills, or autogenous mills. Preferably, step b) is carried out in one wet grinding step.

It is appreciated that wet grinding step b) can be carried out at room temperature or elevated temperatures. It is for example possible that the temperature of the aqueous suspension when starting step b) is of about room temperature, whereas the temperature may rise until the end of wet grinding step b). That is to say, it is preferred that the temperature during wet grinding step b) is not adjusted to a specific temperature.

Alternatively, the temperature during wet grinding step b) is held at a specific temperature by cooling the aqueous suspension.

For the purposes of the process according to the present invention, wet grinding step b) is preferably carried out at a temperature ranging from 2 to 90° C. According to another embodiment, the temperature in wet grinding step b) ranges from 2 to 80° C., preferably from 2 to 70° C., and most preferably from 2 to 60° C.

It is of further advantageous for obtaining a residual total moisture content of ≤0.5 wt.-%, if grinding step b) is carried out in the absence of dispersant(s). For obtaining a residual total moisture content of ≤0.5 wt.-%, it is especially preferred if grinding step b) is carried out by wet grinding in the absence of dispersant(s). More preferably, the grinding step b) is carried out by wet grinding at solids content in the range from 1 to 30 wt.-%, preferably from 2 to 25 wt.-%, based on the total weight of the aqueous suspension, in the absence of dispersant(s). It may be also advantageous to subject the precipitated calcium carbonate obtained after grinding step b) to a dewatering step in order to further reduce the moisture content. Thus, the process for the preparation of the precipitated calcium carbonate preferably comprises a step d) of drying the precipitated calcium carbonate after grinding step b).

For the sake of completeness, it is preferred that the whole process for preparing the precipitated calcium carbonate is carried out in the absence of dispersant(s). Thus, the precipitated calcium carbonate is free of dispersant(s).

It is appreciated that the precipitated calcium carbonate obtained after grinding step b) has a
a weight median particle size d₅₀ of ≤60 μm,
a top cut particle size d₉₈ of ≤500 μm, and
a residual total moisture content of ≤0.5 wt.-%, based on the total dry weight of the precipitated calcium carbonate.

With regard to the definition of the precipitated calcium carbonate and preferred embodiments thereof, reference is made to the statements provided above when discussing the technical details of the precipitated calcium carbonate of the present invention.

As already mentioned above, the precipitated calcium carbonate can be a treated precipitated calcium carbonate.

In this embodiment, the process further comprises step c) in which the precipitated calcium carbonate is contacted under mixing, in one or more steps, with a surface-treatment agent such that a treatment layer comprising the surface-treatment agent and/or salts or reaction products thereof is/are formed on the surface of the precipitated calcium carbonate.

It is appreciated that the treatment layer on the surface of the precipitated calcium carbonate is formed by contacting the calcium or magnesium carbonate-comprising material with the further surface-treatment agent. The precipitated calcium carbonate is contacted with the surface-treatment agent in an amount from 0.1 to 10 mg/m² of the precipitated calcium carbonate surface, preferably 0.1 to 8 mg/m², more preferably 0.11 to 3 mg/m² and most preferably 0.2 to 3 mg/m². That is to say, a chemical reaction may take place between the precipitated calcium carbonate and the surface treatment agent. In other words, the treatment layer may comprise the surface treatment agent and/or salts or reaction products thereof.

Methods for the surface treatment of fillers such as precipitated calcium carbonate are known to the skilled person, and are described, for example, in EP3192837 A1, EP2770017 A1, and WO2016023937.

It is appreciated that the precipitated calcium carbonate in step c) is preferably provided in dry form. Additionally or alternatively, the surface-treatment agent in step c) is preferably provided in dry form. Preferably, the precipitated calcium carbonate in step c) is provided in dry form and the surface-treatment agent in step c) is provided in dry form. In a preferred embodiment, the treated precipitated calcium carbonate is thus prepared in a dry process step. With respect to the process, it is to be noted that the wording “dry form” means that the precipitated calcium carbonate in step c) and/or the surface-treatment agent in step c) is/are provided without the use of solvent(s) such as water.

It is appreciated that the temperature in optional step c) is adjusted such that the surface-treatment agent is in a liquid or molten state but without thermally decomposing the surface-treatment agent. In general, step c) is carried out at a temperature that is at least 2° C., preferably 5° C. above the melting point of the surface-treatment agent.

Additionally or alternatively, step c) is carried out at a temperature ranging from 50 to 130° C., preferably from 60 to 120° C., e.g. from 80 to 120° C.

In one embodiment, step c) is carried out at a temperature that is at least 2° C., preferably 5° C. above the melting point of the surface-treatment agent, and at a temperature ranging from 50 to 130° C., preferably from 60 to 120° C., e.g. from 80 to 120° C.

Step c) is carried out under mixing. It is appreciated that the mixing can be carried out by any method or in any vessel known to the skilled person resulting in a homogeneous composition. For example, step c) is carried out in a high speed mixer or pin mill.

Thus, the treated precipitated calcium carbonate of the present invention is obtainable by a process comprising the steps of:
a) providing a precipitated calcium carbonate having a content of bio-based carbon determined according to DIN EN 16640:2017 of at least 50 wt.-%, preferably at least 60 wt.-%, more preferably at least 65 wt.-%, and most preferably at least 70 wt.-%, based on the total weight of carbon in the material, and
b) grinding the precipitated calcium carbonate of step a) to
   a weight median particle size d₅₀ of ≤60 μm, preferably ≤20 μm, more preferably ≤6 μm, even more preferably ≤3 μm, and most preferably of ≤2 μm,
   a top cut particle size dos of ≤500 μm, preferably ≤200 μm, more preferably ≤20 μm, even more preferably ≤10 μm, and most preferably ≤8 μm, and
c) contacting the precipitated calcium carbonate obtained in step b) under mixing, in one or more steps, with a surface-treatment agent such that a treatment layer comprising the surface-treatment agent and/or salts or reaction products thereof is formed on the surface of the precipitated calcium carbonate.

With regard to the definition of the treated precipitated calcium carbonate and preferred embodiments thereof, reference is made to the statements provided above when discussing the technical details of the precipitated calcium carbonate of the present invention.

It is appreciated that the process for the preparation of the precipitated calcium carbonate may comprise further steps. For example, the process for the preparation of the precipitated calcium carbonate further comprises a step d) of drying the precipitated calcium carbonate before and/or after grinding step b) and optionally before surface-treating step c).

In one embodiment, the process for the preparation of the precipitated calcium carbonate further comprises a step d) of drying the precipitated calcium carbonate before or after grinding step b). If the present process comprises step c) of surface-treating the precipitated calcium carbonate, drying step d) is preferably carried out before surface-treating step c). Such a drying step d), which is carried out before surface-treating step c) is specifically advantageous as step c) is preferably carried out in the absence of solvents.

In another embodiment, the process for the preparation of the precipitated calcium carbonate further comprises a step d) of drying the precipitated calcium carbonate before and after grinding step b).

For example, the drying in step d) is achieved by up-concentration or dewatering to achieve a higher solids content than that of step b) and the solids content achieved in step d) is at least 99 wt.-%, preferably at least 99.5 wt.-%, based on the total weight of the aqueous suspension.

The drying in step d) is carried out by means known to the skilled person such as by mechanical- and/or thermal up-concentration or dewatering and/or combinations thereof.

Mechanical up-concentration or dewatering can be carried out by centrifugation or by filter pressing. Thermal up-concentration or dewatering can be carried out by methods such as solvent evaporation by heat or by flash-cooling or by spray drying.

Preferably, the drying in step d) is carried out by thermal up-concentration such as spray drying. In one embodiment, the thermal up-concentration is carried out in combination with vacuum.

In one embodiment, the drying in step d) is carried out such as to achieve a higher solids content than that of step b) and the solids content achieved in step d) is at least 99.7 wt.-%, preferably of at least 99.8 wt.-% and most preferably at least 99.9 wt.-%, based on the total weight of the precipitated calcium carbonate. Preferably, the precipitated calcium carbonate is thus a dry precipitated calcium carbonate.

It is appreciated that the drying in step d) is carried out without a decrease in particle size of the precipitated calcium carbonate.

Additionally or alternatively, the process for the preparation of the precipitated calcium carbonate further comprises a step e) of dry-grinding and/or wet-grinding the precipitated calcium carbonate before grinding step b). Preferably, the process for the preparation of the precipitated calcium carbonate further comprises a step e) of dry-grinding or wet-grinding the precipitated calcium carbonate before grinding step b). More preferably, the process for the preparation of the precipitated calcium carbonate further comprises a step e) of dry-grinding the precipitated calcium carbonate before grinding step b).

It is appreciated that such grinding step e) is preferably carried out in that the precipitated calcium carbonate provided in step a) is ground to a weight median particle size d₅₀ of ≤100 μm, preferably of ≤10 μm.

In general, grinding step e) can be carried out by any grinding means and grinding devices known in the art for example, under conditions such that refinement predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. Preferably, grinding step e) is carried out in a ball mill, more preferably in a ball mill without the use of dry grinding aid(s).

If the process for the preparation of the precipitated calcium carbonate comprises grinding step e), it is appreciated that the product resulting from grinding step e) is used as a feed for subsequent grinding step b). In this embodiment, it is especially preferred that the product resulting from grinding step e) is used as a feed for the subsequent grinding step b) which is carried out by wet-grinding.

With regard to the grinding and preferred embodiments thereof, reference is made to the statements provided above when discussing process step b) of the present invention.

Articles, their Preparation and Uses

Another aspect of the present invention refers to a polymer formulation comprising a polymer resin and the precipitated calcium carbonate as defined herein, wherein the precipitated calcium carbonate according is dispersed in the polymer resin.

With regard to the definition of the precipitated calcium carbonate and preferred embodiments thereof, reference is made to the statements provided above when discussing the technical details of the precipitated calcium carbonate of the present invention.

The polymer formulation preferably comprises the precipitated calcium carbonate in an amount ranging from 3 to 85 wt.-%, preferably from 3 to 82 wt.-%, based on the total weight of the formulation.

It should be noted that the polymer resin may be one kind of polymer resin. Alternatively, the polymer resin may be a mixture of two or more kinds of polymer resins. For example, the polymer resin may be a mixture of two or three kinds of polymer resins, like two kinds of polymer resins.

In one embodiment of the present invention, the polymer resin comprises, preferably consists of, one kind of polymer resin.

The polymer resin is preferably selected from the group comprising polyester, polyolefin, polyamide and mixtures thereof.

For example, the polymer resin is selected from the group comprising, e.g. consisting of, polyethylene, polypropylene, polylactic acid, polylactic acid-based polymer, polyhydroxyalkanoates (PHA), e.g. polyhydroxybutyrate (PHB), poly-3-hydroxybutyrate (P3HB), poly3-hydroxybutyrate-co-3-hydroxyhexanoate (PHBH), polyhydroxyvalerate, polyhydroxybutyrate-polyhydroxyvalerate copolymer, poly(3-hydroxybutyrate-co-3-hydroxyvalerate) (PHBV); polybutyrate-adipate-terephthalate (PBAT), polyglyconate, polyethylene terephthalate (PET), polycarbonate (PC), poly(dioxanone), polybutylene succinate (PBS), polycaprolactone (PCL), polycaprolactone-poly(ethylene glycol) copolymer, polycaprolactone-polylactic acid copolymer, polyvinylalcohol (PVA), poly(ethylene succinate) (PES), poly(propylene succinate) (PPS), and mixtures thereof,

Preferably, the polymer resin is a polyester, more preferably the polymer resin is selected from the group comprising, e.g. consisting of, polylactic acid, polylactic acid-based polymer, polyhydroxyalkanoates (PHA), polyethylene terephthalate (PET), polybutylene succinate (PBS), polycaprolactone (PCL), polybutyrate-adipate-terephthalate (PBAT) and mixtures thereof.

More preferably, the polymer resin is selected from the group comprising, e.g. consisting of, polylactic acid, polylactic acid-based polymer, polyhydroxyalkanoates (PHA) polyethylene terephthalate (PET), and mixtures thereof.

Alternatively, the polymer resin is an elastomer resin.

Preferably, the polymer resin is an elastomer resin selected from natural or synthetic rubber, more preferably from the group consisting of acrylic rubber, butadiene rubber, acrylonitrile-butadiene rubber, epichlorhydrin rubber, isoprene rubber, ethylene-propylene rubber, ethylene-propylene-diene monomer rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, thermoplastic starch (TPS), and mixtures thereof.

Such polymer resins are well known and do not need to be described in more detail herein.

In order to increase the content of bio-based carbon, it is preferred that the polymer resin is a biobased polymer resin, such as a partially or fully biobased polymer resin in which the monomers are derived from renewable biomass sources. It is appreciated that a biobased polymer is a polymer having a biobased carbon content of more than 20 wt.-%, based on the total weight of the polymer resin. Preferably, the biobased polymer is a polymer having a biobased carbon content of more than 40 wt.-%, more preferably more than 50 wt.-%, and most preferably more than 80 wt.-%, based on the total weight of the polymer resin.

For example, the polymer resin is a biobased polyolefin, thermoplastic starch or polyester resin. Thus, the polymer resin is preferably a biobased polyester resin that is selected from the group comprising, e.g. consisting of, polylactic acid, polylactic acid-based polymer, polyhydroxyalkanoates (PHA), polyethylene terephthalate (PET), polybutylene succinate (PBS), polycaprolactone (PCL), polybutyrate-adipate-terephthalate (PBAT) and mixtures thereof, a biobased thermoplastic starch (TPS) or a biobased polyethylene (PE), polypropylene (PP) and mixtures thereof. More preferably, the polymer resin is a bio-based polyester resin or a mixture of biobased polyester resins.

In one embodiment, the biobased polyester resin is selected from the group comprising, e.g. consisting of, polylactic acid, polylactic acid-based polymer and mixtures thereof. Preferably, the biobased polyester resin of the present invention is polylactic acid.

Polylactic acid may be prepared in a well-known manner and is commercially available from different manufacturers such as Cereplast Inc, Mitsui Chemicals Inc, Gehr GmbH or NatureWorks and many more.

There is no specific limitation on the molecular weight of the biobased polymer resin used in this invention. However, the number average molecular weight Mn measured by gel permeation chromatography from 5 000 to 200 000 g/mol, preferably from 10 000 to 100 000 g/mol, and more preferably from 15000 to 80000 g/mol. If the number average molecular weight is smaller than the aforementioned range, the mechanical strength (tensile strength, impact strength) of the polymer formulation is too low. On the other hand, if the number average molecular weight is larger than the aforementioned range, the melt viscosity may be too high for carrying out the processing.

Examples of polylactic acid-based resins suitable for the instant polymer formulation include copolymers of lactic acid and blends of polylactic acids.

If the polylactic acid-based resin is a copolymer, the polylactic acid-based resin may comprise further copolymer components in addition to lactic acid. Examples of the further copolymer component include hydroxybutyric acid, 3-hydroxybutyric acid, hydroxyvaleric acid, 3-hydroxyvaleric acid and citric acid.

The polymer formulation may further comprise additives, such as colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin.

According to one embodiment, the polymer formulation can comprise a filler differing from the precipitated calcium carbonate of the present invention, preferably the other filler is selected from the group comprising carbon black, silica, ground natural calcium carbonate, precipitated calcium carbonate, nanofillers, graphite, clay, talc, diatomaceous earth, barium sulfate, titanium dioxide, wollastonite, and mixtures thereof. Preferably, the polymer formulation comprises another filler, such as carbon black, TiO₂, mica, clay, precipitated silica, talc or calcined kaolin.

If the polymer formulation comprises a filler differing from the precipitated calcium carbonate of the present invention, it is appreciated that the precipitated calcium carbonate of the present invention is the main filler. That is to say, the amount of the precipitated calcium carbonate exceeds the amount of the filler differing from the precipitated calcium carbonate.

It is appreciated that the present invention further relates to an article formed from the polymer formulation as defined herein.

With regard to the definition of the polymer formulation and preferred embodiments thereof, reference is made to the statements provided above when discussing the technical details of the polymer formulation of the present invention.

The article is preferably selected from the group comprising hygiene products, medical and healthcare products, filter products, geotextile products, agriculture and horticulture products, clothing, footwear and baggage products, household and industrial products, packaging products, construction products, automotive parts, bottles, cups, bags, straws, flooring products, and the like.

The article may be prepared by any method known to the skilled person. A suitable process for preparing the article comprises the steps of:
a) providing a polymer resin,
b) providing a precipitated calcium carbonate as defined herein as filler,
c) optionally providing further additives such as colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin,
d) contacting the components of step a), step b), and optionally step c) in any order to form a polymer formulation, and
e) forming the polymer formulation of step d) such that an article is obtained.

In one embodiment, the article further comprises additive(s). The process thus comprises the steps of
a) providing a polymer resin,
b) providing a precipitated calcium carbonate as defined herein as filler,
c) providing further additives such as colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin,
d) contacting the components of step a), step b), and step c) in any order to form a polymer formulation, and
e) forming the polymer formulation of step d) such that an article is obtained.

According to step d) of the inventive process, the components of step a) and step b) are contacted in any order. Preferably, the contacting is carried out by mixing the components to form a polymer formulation. During contacting step d), optionally one or more additives and other fillers may be added to the polymer formulation.

Preferably, in contacting step d) the precipitated calcium carbonate of step b) is contacted under mixing, in one or more steps, with the polymer resin of step a) first, and if present with the additives and other fillers in a following step.

Thus, if present, the further additives of step c) are contacted under mixing, in one or more steps, with the precipitated calcium carbonate before or after, preferably after, the precipitated calcium carbonate is contacted under mixing, in one or more steps, with the polymer resin of step a).

It is appreciated that the further additives of optional step c) can be contacted in one or more steps with the components of step a) and step b). For example, the further additives of optional step c) can be contacted in several steps with the components of step a) and step b).

Contacting step d) may be performed by any means known to the skilled person, including, but not limited to, blending, extruding, kneading, and high-speed mixing.

Preferably, contacting step d) is performed in an internal mixer and/or external mixer, wherein the external mixer preferably is a cylinder mixer. It is appreciated that step d) is preferably carried out at a temperature of at least 2° C., preferably at least 5° C. and most preferably at least 10° C. above the melting point of the polyester resin. For example, step d) is carried out at a temperature of 2° C. to 30° C., preferably of 5° C. to 25° C., and most preferably 10° C. to 20° C., above the melting point of the polyester resin.

The mixture obtained in step d) is formed to article in step e). The forming may be performed by any method known to the skilled person resulting in a polymeric article. These methods include, without being limited to, extrusion processes, co-extrusion process, extrusion coating processes, lamination processes, injection molding processes, compression molding process, melt-blown processes, spunbonding-processes, staple fiber production processes, blow molding processes and thermoforming processes.

Preferably, contacting step d) is carried out during forming step e).

It is appreciated that the process may comprise further steps such as processing the article in any desired shape. Such steps of processing are well known to the skilled person and can be e.g. carried out by shaping the article for example by stretching of a film.

In another aspect, the present invention relates to the use of the precipitated calcium carbonate as defined herein in a polymer formulation comprising a polymer resin, preferably the polymer resin is selected from the group comprising polyester, polyolefin, polyamide and mixtures thereof, more preferably polyethylene, polypropylene, polylactic acid, polylactic acid-based polymer, polyhydroxyalkanoates (PHA), e.g. polyhydroxybutyrate (PHB), poly-3-hydroxybutyrate (P3HB), poly3-hydroxybutyrate-co-3-hydroxyhexanoate (PHBH), polyhydroxyvalerate, polyhydroxybutyrate-polyhydroxyvalerate copolymer, poly(3-hydroxybutyrate-co-3-hydroxyvalerate) (PHBV); polybutyrate-adipate-terephthalate (PBAT), polyglyconate, polyethylene terephthalate (PET), polycarbonate (PC), poly(dioxanone), polybutylene succinate (PBS), polycaprolactone (PCL), polycaprolactone-poly(ethylene glycol) copolymer, polycaprolactone-polylactic acid copolymer, polyvinylalcohol (PVA), poly(ethylene succinate)(PES), poly(propylene succinate) (PPS), and mixtures thereof, most preferably polylactic acid, polylactic acid-based polymer, polyhydroxyalkanoates (PHA) polyethylene terephthalate (PET), and mixtures thereof or the polymer resin is an elastomer resin, preferably an elastomer resin selected from natural or synthetic rubber, more preferably from the group consisting of acrylic rubber, butadiene rubber, acrylonitrile-butadiene rubber, epichlorhydrin rubber, isoprene rubber, ethylene-propylene rubber, ethylene-propylene-diene monomer rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, thermoplastic starch (TPS), and mixtures thereof.

With regard to the definition of the precipitated calcium carbonate, polymer formulation and preferred embodiments thereof, reference is made to the statements provided above when discussing the technical details of the precipitated calcium carbonate and polymer formulation of the present invention.

The scope and interest of the invention will be better understood based on the following examples which are intended to illustrate certain embodiments of the present invention and are non-limitative.

### EXAMPLES

### I. Analytical Methods

### BET Specific Surface Area of a Material

Throughout the present document, the specific surface area (in m²/g) of the mineral filler was determined using the BET method (using nitrogen as adsorbing gas), which is well known to the skilled man (ISO 9277:2010). The total surface area (in m²) of the mineral filler was then obtained by multiplication of the specific surface area and the mass (in g) of the mineral filler prior to treatment.

Particle Size Distribution (Mass % Particles with a Diameter <X) and Weight Median Diameter (d₅₀) of a Particulate Material

As used herein and as generally defined in the art, the “d₅₀” value was determined based on measurements made by using a Sedigraph™ 5120 of Micromeritics Instrument Corporation and is defined as the size at which 50% (the median point) of the particle mass is accounted for by particles having a diameter equal to the specified value.

The method and the instrument are known to the skilled person and are commonly used to determine grain size of fillers and pigments. The measurement is carried out in an aqueous solution of 0.1 wt.-% Na₄P₂O₇. The samples are dispersed using a high speed stirrer and supersonics.

### Moisture Pick Up Susceptibility

The moisture pick up susceptibility of a material as referred to herein was determined in mg moisture/g after exposure to an atmosphere of 10 and 85% relative humidity, respectively, for 2.5 hours at a temperature of +23° C. (±2° C.). The measurements were made in a GraviTest 6300 device from Gintronic. For this purpose, the sample was first kept at an atmosphere of 10% relative humidity for 2.5 hours, then the atmosphere was changed to 85% relative humidity at which the sample is kept for another 2.5 hours. The weight increase between 10 and 85% relative humidity was then used to calculate the moisture pick-up in mg moisture/g of sample.

### Amount of Surface-Treatment Layer

The amount of the at least one hydrophobizing agent on the precipitated calcium carbonate was calculated theoretically from the values of the BET of the untreated precipitated calcium carbonate and the amount of at least one hydrophobizing agent that were used for the surface-treatment.

The amount of the at least one hydrophobizing agent in the surface-treated precipitated calcium carbonate was determined by thermogravimetric analysis (TGA). TGA was performed using a Mettler Toledo TGA/DSC3+ based on a sample of 250±50 mg in a 900 μL crucible and scanning temperatures from 25 to 400° C. at a rate of 20° C./minute under an air flow of 80 ml/min. The total volatiles associated with precipitated calcium carbonate and evolved over a temperature range of 25 to 280° C. or 25 to 400° C. was characterized according to % mass loss of the sample over a temperature range as read on a thermogravimetric (TGA) curve. The total weight of the at least one hydrophobizing agent on the accessible surface area of the precipitated calcium carbonate was determined by thermogravimetric analysis by mass loss between 105° C. to 400° C., whereby the obtained value of mass loss between 105° C. to 400° C. was subtracted with the mass loss (105 to 400° C.) of the not-surface-treated precipitated calcium carbonate for correction.

### Total Residual Moisture Content

The residual total moisture content was determined by thermogravimetric analysis (TGA). The equipment used to measure the total residual moisture content by TGA was the Mettler-Toledo TGA/DSC1 (TGA 1 STARe System) and the crucibles used were aluminium oxide 900 μl. The method consists of several heating steps under air (80 mL/min). The first step was a heating from 25 to 105° C. at a heating rate of 20° C./minute (step 1), then the temperature was maintained for 10 minutes at 105° C. (step 2), then heating was continued at a heating rate of 20° C./minute from 105 to 400° C. (step 3). The temperature was then maintained at 400° C. for 10 minutes (step 4), and finally, heating was continued at a heating rate of 20° C./minute from 400 to 600° C. (step 5). The residual total moisture content is the cumulated weight loss after steps 1 and 2.

Alternatively, the residual total moisture content was determined by Karl-Fischer coulometry. The equipment used to measure the total residual moisture content by Karl-Fischer coulometry was a Karl-Fischer Coulometer (C 30 oven: Mettler Toledo Stromboli, Mettler Toledo, Switzerland) at 220° C. under nitrogen (flow 80 ml/min, heating time 10 min). The accuracy of the result is checked with a HYDRANAL-Water Standard KF-Oven (Sigma-Adrich, Germany), measured at 220° C.).

### X-Ray Diffraction (XRD)

XRD experiments are performed on the samples using rotatable PMMA holder rings. Samples are analysed with a Bruker D8 Advance powder diffractometer obeying Bragg's law. This diffractometer consists of a 2.2 KW X-ray tube, a sample holder, a 9-9-goniometer, and a VÅNTEC-1 detector. Nickel-filtered Cu Kα radiation is employed in all experiments. The profiles are chart recorded automatically using a scan speed of 0.7° per min in 29. The resulting powder diffraction pattern can easily be classified by mineral content using the DIFFRACsuite software packages EVA and SEARCH, based on reference patterns of the ICDD PDF 2 database. Quantitative analysis of diffraction data refers to the determination of amounts of different phases in a multi-phase sample and has been performed using the DIFFRACsuite software package TOPAS. In detail, quantitative analysis allows to determine structural characteristics and phase proportions with quantifiable numerical precision from the experimental data itself. This involves modelling the full diffraction pattern (Rietveld approach) such that the calculated pattern(s) duplicates the experimental one. The Rietveld method requires knowledge of the approximate crystal structure of all phases of interest in the pattern. However, the use of the whole pattern rather than a few select lines produces accuracy and precision much better than any single-peak-intensity based method.

### Pigment Whiteness R457 and Brightness Ry

Pigment whiteness R457 and brightness Ry were measured on a tablet (prepared on an Omyapress 2000, pressure=4 bar, 15 s) using a Datacolor ELREPHO (Datacolor AG, Switzerland) according to ISO 2469:1994 (DIN 53145-1:2000 and DIN 53146:2000).

### CIELAB Coordinates

The CIELAB L*, a*, b* coordinates were measured using a Datacolor ELREPHO (Datacolor AG, Switzerland) according to EN ISO 11664-4 and barium sulphate as standard.

### Yellow Index

The CIE coordinates were measured using a Datacolor ELREPHO (Datacolor AG, Switzerland). The yellow index (=YI) is calculated by the following formula:

YI=100*(Rₓ-R_{z})/R_{y}).

### Melt Flow Rate

The melt flow index was measured according to ISO 1133-1:2011 on a CEAST Instrument equipped with the software Ceast View 6.15 4C. The length of the die was 8 mm and its diameter was 2.095 mm. Measurements were performed at 210° C. with 300 s of preheating without load, then a nominal load of 2.16 kg is used and the melt flow was measured along 20 mm.

### Capillary Rheology

The viscosity was measured on a CEAST SR20 capillary rheometer, equipped with a 20 kN cell, a 100 MPa pressure transducer and a ø 1.000 mm L/D=20 capillary. Measurements were performed at 265° C. with 600 s of preheating without load, then the measurement was made with a shear rate of 500 s⁻¹ for 60 s. Pellets were dried before the measurement.

### Tensile Properties

The tensile properties were measured according to ISO527-1:2012 Type BA (1:2) on a Allround Z020 traction device from Zwick Roell. Measurements were performed with an initial load of 0.1 MPa. For the measurement of the E-modulus a speed of 1 mm/min is used, then it was increased to 100 mm/min. The tensile strain at break was obtained under standard conditions. All measurements were performed on samples that have been stored under similar conditions after preparation.

### Impact Properties

The impact properties were measured according to ISO 179-1eA: 2010-11 on a HIT5.5P device from Zwick Roell. Measurements for PLA formulations were performed on V-notched samples with a hammer of 0.5 J. All measurements were performed on samples that have been stored under similar conditions after preparation.

### Water Vapour Transmission Rate (WVTR)

The WVTR value of the breathable films was measured with Lyssy L80-5000 (PBI-Dansensor A/S, Denmark) measuring device according to ASTM E398.

### Filter Pressure Test

A filter pressure test was carried out in order to determine the dispersion quality. The filter pressure test was performed on a commercially available Collin Pressure Filter Test Teach-Line FT-E20T-IS. The test method was performed in agreement with European Standard EN 13900-5 with each of the corresponding polymer compositions (16 g effective calcium carbonate per 200 g of final sample, diluent: LLDPE Exxon Mobil LL 1001 VX) using a 14 μm type 30 filter (GKD Gebr. Kufferath AG, Düren, Germany), wherein no melt pump was used, the extruder was kept at 100 rpm, and wherein the melt temperature was 225 to 230° C. (temperature setting: 190° C./210° C./230° C./230° C./230° C.)

### Hydrostatic Pressure Test

The hydrostatic pressure test has been carried out according to a procedure which is equivalent to AATCC Test Method 127-2013, WSP 80.6 and ISO 811. A film sample (test area=10 cm2) was mounted to form a cover on the test head reservoir. This film sample was subjected to a standardized water pressure, increased at a constant rate until leakage appears on the outer surface of the film, or water burst occurred as a result of film failure (pressure rate gradient=100 mbar/min). Water pressure was measured as the hydrostatic head height reached at the first sign of leakage in three separate areas of the film sample or when burst occurs. The head height results were recorded in centimeters or millibars of water pressure on the specimen. A higher value indicated greater resistance to water penetration. The TEXTEST FX-3000, Hydrostatic Head Tester (Textest AG, Switzerland), was used for the hydrostatic pressure measurements.

### Moisture Aquatrac

Moisture of pellets was determined with a Brabender Aquatrac-3E equipment at 190° C. The polymer pellets were preconditioned in a Motan dry air drier MDE 40 for 4 hours at 80° C. Before the measurement in Aquatrac. The Aquatrac equipment measures the pressure caused by the reaction of the evaporated water of the pellets with calcium hydride agent. With the resulting pressure the moisture will be calculated by the equipment. For the measurement the procedure given by the manual was followed.

### Oxidative Induction Time (OIT)

The oxidative oxidation time was measured on a DSC3+ from Mettler Toledo at 220° C. for 60 minutes under an oxygen flow of 50 mL/min.

### II. Materials

a. Treatment Agents

### Surface-Treatment Agent 1

Surface treatment agent 1 was a mono-substituted alkenyl succinic anhydride (2,5-Furandione, dihydro-, mono-C15-20-alkenyl derivs., CAS No. 68784 Dec. 3), which was a blend of mainly branched octadecenyl succinic anhydrides (CAS #28777-98-2) and mainly branched hexadecenyl succinic anhydrides (CAS #32072-96-1). More than 80% of the blend was branched octadecenyl succinic anhydrides. The purity of the blend was >95 wt %. The residual olefin content was below 3 wt %.

### Surface-Treatment Agent 2

Surface treatment agent 2 was a 40:60 mixture of stearic acid and palmitic acid.

b. Mineral Powders

### COMPARATIVE EXAMPLES

### Calcium Carbonate CC1

The calcium carbonate CC1 was a wet ground and spray dried marble from Italy (d₅₀=1.9 μm, d₉₈=5.8 μm, BET=3.5 m²/g).

### Treated Calcium Carbonate CC2

The treated calcium carbonate CC2 was a wet ground and spray dried marble from Italy, treated with surface treatment agent 2 (d₅₀=1.9 μm, d₉₈=5.8 μm, BET=3.5 m²/g).

### Treated Calcium Carbonate CC3

The calcium carbonate CC3 was a wet ground and spray dried marble from Italy treated with surface treatment agent 1 (d₅₀=1.9 μm, d₉₈=5.8 μm, BET=3.5 m²/g).

### Lab Trials

### Precipitated Calcium Carbonate CC4

The calcium carbonate CC4 was PCC beads obtained from fast water decarbonization plants (beads size: 0.8-1.2 mm, % finer than 0.8 mm: 2%, % finer than 1.25 mm: 99%).

### Precipitated Calcium Carbonate CC5

The precipitated calcium carbonate CC5 was obtained by dry grinding of precipitated calcium carbonate beads obtained from fast water decarbonization plants. (CaCO₃: 99%, MgCO₃:0.4%, Fe₂O₃:11 ppm, Al₂O₃:21 ppm, SiO₂: 0.02%, d₅₀=5 μm, d₉₈=28 μm (Malvern 3000 wet), BET=2.4 m²/g).

### Precipitated Calcium Carbonate CC6

The precipitated calcium carbonate CC6 has been prepared by dry grinding powder CC5 on a ZPS classifier mill (Hosokawa Alpine Multiprocess unit). A bright white powder was obtained (d₅₀=1.8 μm, d₉₈=4.0 μm (Malvern 3000 wet), BET=3.5 m²/g).

### Precipitated Calcium Carbonate CC7

The precipitated calcium carbonate CC7 has been prepared by wet grinding powder CC5 at low solid content (18%) without additives on a Dyno-mill ECM-AP 05, followed by filtration and drying. The dried filter cake was then deagglomerated on a pin mill. A bright white powder was obtained (d₅₀=1.6 μm, d₉₈=6.0 μm (Malvern 3000 wet), BET=6.1 m²/g).

### Treated Precipitated Calcium Carbonate CC8

The treated precipitated calcium carbonate CC8 has been prepared by surface treatment of powder CC6 with surface treatment agent 1. For this, 300 g of powder CC6 were placed in a 2.5 L mixer vessel (Somakon MP-LB Mixer, Somakon Verfahrenstechnik, Germany), and conditioned by stirring for 5 minutes (600 rpm, 120° C.). After that time, 0.7 parts by weight relative to 100 parts by weight CaCO₃ of surface treatment agent 1 were added dropwise to the mixture. Stirring and heating were then continued for another 10 minutes (120° C., 600 rpm). After that time, the mixture was allowed to cool and the free-flowing hydrophobic powder was collected (powder CC8).

Treated precipitated calcium carbonate CC9

The treated precipitated calcium carbonate CC9 has been prepared by surface treatment of powder CC7 with surface treatment agent 1. For this, 300 g of powder CC7 were placed in a 2.5 L mixer vessel (Somakon MP-LB Mixer, Somakon Verfahrenstechnik, Germany), and conditioned by stirring for 5 minutes (600 rpm, 120° C.). After that time, 1.2 parts by weight relative to 100 parts by weight CaCO₃ of surface treatment agent 1 were added dropwise to the mixture. Stirring and heating were then continued for another 10 minutes (120° C., 600 rpm). After that time, the mixture was allowed to cool and the free-flowing hydrophobic powder was collected (powder CC9).

### Treated Precipitated Calcium Carbonate CC10

The treated precipitated calcium carbonate CC10 has been prepared by surface treatment of powder CC6 with surface treatment agent 2. For this, 300 g of powder CC6 were placed in a 2.5 L mixer vessel (Somakon MP-LB Mixer, Somakon Verfahrenstechnik, Germany), and conditioned by stirring for 5 minutes (600 rpm, 120° C.). After that time, 0.8 parts by weight relative to 100 parts by weight CaCO₃ of surface treatment agent 2 were added to the mixture. Stirring and heating were then continued for another 10 minutes (120° C., 600 rpm). After that time, the mixture was allowed to cool and the free-flowing hydrophobic powder was collected (powder CC10).

### Pilot Trials

### Precipitated Calcium Carbonate CC11

The precipitated calcium carbonate CC11 has been prepared by wet grinding powder CC5 at low solid content (25 wt %) without additives, followed by upconcentration on a Andritz D2L centrifuge. The cake was then diluted to reach a 50 wt % solids concentration and was then spray dried on a Niro Atomizer. A bright white powder was obtained (d₅₀=2.3 μm, d₉₈=8.0 μm (Sedigraph), BET=5.0 m²/g). The precipitated calcium carbonate 11 had an amount of calcite of 99.8 wt.-% and acid insoluble in an amount of 0.06 wt.-% as determined by XRD and normalized to 100 wt.-% crystalline material.

### Treated Precipitated Calcium Carbonate CC12

The treated precipitated calcium carbonate CC12 has been prepared by surface treatment of powder CC11 with surface treatment agent 1. Treatment was carried out in a Contraplex Pin mill device at 300 kg/h flow rate and a pin mill speed of 4000 rpm (door) and 8000 rpm (housing). Classifier speed was set to 2000 rpm. The powder was pre-heated at 120° C. and surface treatment agent 1 was added during the process (0.92 parts by weight relative to 100 parts by weight CaCO₃). A white hydrophobic powder was obtained (CC12)

### Treated Precipitated Calcium Carbonate CC13

The treated precipitated calcium carbonate CC13 has been prepared by surface treatment of powder CC11 with treatment agent surface treatment agent 2. Treatment was carried out in a Contraplex Pin mill device at 300 kg/h flow rate and a pin mill speed of 4000 rpm (door) and 8000 rpm (housing). Classifier speed was set to 2000 rpm. The powder was pre-heated at 120° C. and surface treatment agent 2 was added during the process (1.13 parts by weight relative to 100 parts by weight CaCO₃). A white hydrophobic powder was obtained (CC13)

### Treated Precipitated Calcium Carbonate-Containing Filler Material CC14

The treated precipitated calcium carbonate CC14 has been prepared by surface treatment of powder CC11 with surface treatment agent 1. Treatment was carried out in a Lödige Ploughshare mixer on a 40 kg scale. The powder was pre-heated at 60° C. and surface treatment agent 1 was added and subsequently mixed with main mixer and chopper unit running until the temperature reached 90° C. (0.75 parts by weight relative to 100 parts by weight CaCO₃). The mixture was then cooled down to 50° C. and a white hydrophobic powder was obtained (CC14).

c. Powder Properties

The content of bio-based carbon of the precipitated calcium carbonates as determined according to DIN EN 16640:2017 in wt.-%, based on the total weight of carbon in the precipitated calcium carbonate, is set out in the following table 1.

TABLE 1

| | % Biobased carbon as a fraction of total |
|---|---|
| | carbon (% modern carbon*) |
| CC3 | <0.44% |
| CC5 | 71.12 ± 0.23% |
| CC11 | 69.04 ± 0.22% |
| CC12 | 65.84 ± 0.22% |
| CC13 | 69.56 ± 0.21% |
| CC4 | 76.37 ± 0.23% |

“% modern carbon” (pMC) is the percentage of C14 measured in the sample relative to a modern reference standard (NIST 4990C). The % Biobased carbon content is calculated from pMC by applying a small adjustment factor for C14 in carbon dioxide in air today. It is important to note that all internationally recognized standards using C14 assume that the plant or biomass feedstocks were obtained from natural environments. In case of a treated material, the bio-based carbon content is determined on the treated material, i.e. after surface-treatment.

The BET specific surface area measured using nitrogen and the BET method according to ISO 9277 as well as the residual total moisture content and moisture pick-up susceptibility of the precipitated calcium carbonates determined by Karl Fischer coulometry, based on the total dry weight of the precipitated calcium carbonate, are set out in the following table 2.

TABLE 2

| | | | | Moisture by |
|---|---|---|---|---|
| | | | Moisture | Karl-Fischer |
| | | BET | pick-up | coulometry |
| Sample | Treatment | (m²/g) | (mg/g) | (ppm) |
| CC1 | — | | | |
| CC2 | surface treatment | 3.7 | 0.3 | 668 |
| | agent 2 | | | |
| CC3 | surface treatment | 3.7 | 0.4 | 941 |
| | agent 1 | | | |
| CC5 | — | 2.4 | 2.7 | 2609 |
| CC6 | — | 3.5 | 5.3 | 5281 |
| CC7 | — | 6.1 | 2.9 | 2273 |
| CC8 | 0.7% surface | 3.5 | 2,0 | 2490 |
| | treatment agent 1 | | | |
| CC9 | 1.2% surface | 6.3 | 1.5 | 1741 |
| | treatment agent 1 | | | |
| CC10 | 0.8% surface | 3.5 | 1.8 | 2769 |
| | treatment agent 2 | | | |
| CC11 | — | 5.0 | 2.1 | 1560 |
| CC12 | 0.92% surface | 3.8 | 0.5 | 900 |
| | treatment agent 1 | | | |
| CC13 | 1.13% surface | 3.5 | 0.4 | 589 |
| | treatment agent 2 | | | |
| CC14 | 0.75% surface | 4.1 | 0.8 | 812 |
| | treatment agent 1 | | | |

The powders optical characteristics such as brightness Ry, yellow index YI and L*/a*/b* of the precipitated calcium carbonates are set out in the following table 3.

TABLE 3

| | | | Yellow | |
|---|---|---|---|---|
| | | Brightness | index/ | |
| Sample | Treatment | Ry (%) | YI | L*/a*/b* |
| CC1 | -— | | | |
| CC2 | Surface treatment | 92.8 | 1.4 | 97.1/0.00/0.74 |
| | agent 2 | | | |
| CC3 | Surface treatment | 93.1 | 1.5 | 97.3/−0.01/0.81 |
| | agent 1 | | | |
| CC5 | — | 96.0 | 3.3 | 98.4/0.16/1.72 |
| CC6 | — | 97.0 | 2.3 | 98.8/0.10/1.21 |
| CC7 | — | 97.0 | 1.7 | 98.8/0.05/0.90 |
| CC8 | 0.7% surface | 96.6 | 2.7 | 98.6/0.11/1.39 |
| | treatment agent 1 | | | |
| CC9 | 1.2% surface | 96.3 | 1.9 | 98.5/0.07/1.00 |
| | treatment agent 1 | | | |
| CC10 | 0.8% surface | 96.6 | 2.5 | 98.6/0.12/1.29 |
| | treatment agent 2 | | | |
| CC11 | — | 96.3 | 2.8 | 98.5/0.10/1.48 |
| CC12 | 0.92% surface | 95.7 | 3.3 | 98.3/0.09/1.75 |
| | treatment agent 1 | | | |
| CC13 | 1.13% surface | 95.5 | 3.3 | 98.2/0.11/1.74 |
| | treatment agent 2 | | | |
| CC14 | 0.75% surface | 95.7 | 3.5 | 98.3/0.09/1.82 |
| | treatment agent 1 | | | |

The TGA results of the precipitated calcium carbonate samples are set out in the following table 4.

TABLE 4

| | | TGA loss | TGA loss |
|---|---|---|---|
| | | 25-105° C. | 105-400° C. |
| Sample | Treatment | (wt %) | (wt %) |
| CC1 | — | 0.06 | 0.08 |
| CC2 | surface treatment | 0.06 | 0.74 |
| | agent 2 | | |
| CC3 | surface treatment | 0.03 | 1.05 |
| | agent 1 | | |
| CC5 | — | 0.10 | 0.30 |
| CC6 | — | 0.06 | 0.38 |
| CC7 | — | 0.06 | 0.38 |
| CC8 | 0.7% surface | 0.08 | 1.14 |
| | treatment agent 1 | | |
| CC9 | 1.2% surface | 0.05 | 1.34 |
| | treatment agent 1 | | |
| CC10 | 0.8% surface | 0.09 | 1.22 |
| | treatment agent 1 | | |
| CC11 | — | 0.04 | 0.33 |
| CC12 | 0.92% surface | 0.02 | 1.20 |
| | treatment agent 1 | | |
| CC13 | 1.13% surface | 0.01 | 1.35 |
| | treatment agent 2 | | |
| CC14 | 0.75% surface | 0.02 | 1.03 |
| | treatment agent 1 | | |

c. Application Examples

### 1. Lab Trials in PLA

Compounding and Injection Compounding in PLA (Ingeo™ 2003D from Natureworks) was performed on a lab twin screw extruder. PLA was first crushed to <1 mm particles with a Retsch SR300 rotor beater mill, and dried 2 h at 80° C. prior to compounding.

### Extrusion Conditions:

Twin-screw extruder 25:1 from Three Tec (Extruder Type ZE12, die: 0.5 mm)
T1=170° C.
T2=190° C.
T3=190° C.
T4=180° C.

The samples compounded are summarized in the following tables 5 and 6.

TABLE 5

| | PLA | CC3 | CC2 | CC6 | CC7 |
|---|---|---|---|---|---|
| Sample | (pbw) | (pbw) | (pbw) | (pbw) | (pbw) |
| S3 - PLA CC0 | 100 | | | | |
| S3 - PLA CC3 | 80 | 20 | | | |
| S3 - PLA CC2 | 80 | | 20 | | |
| S3 - PLA CC6 | 80 | | | 20 | |
| S3 - PLA CC7 | 80 | | | | 20 |

pbw: throughout the present invention, “pbw” refers to “parts by weight”.

TABLE 6

| | PLA | CC8 | CC9 | CC10 | CC5 |
|---|---|---|---|---|---|
| Sample | (pbw) | (pbw) | (pbw) | (pbw) | (pbw) |
| S3 - PLA CC8 | 80 | 20 | | | |
| S3 - PLA CC9 | 80 | | 20 | | |
| S3 - PLA CC10 | 80 | | | 20 | |
| S3 - PLA CC5 | 80 | | | | 20 |

For mechanical properties testing, sample specimens were produced by injection molding using a Xplore IM12 injection moulder from Xplore Instruments B.V with the settings indicated in the following table 7:

TABLE 7

| | | |
|---|---|---|
| Melt temperature | 210° C. | |
| Mould temperature | 65° C. | |
| Melting time | 3 min | |
| Pressure 1 + time | 7 bars | 1 s |
| Pressure 2 + time | 7 to 8 bars | 2 s |
| Pressure 3 + time | 8 bars | 10 s |

The ash content in [%] of the compounds was determined by incineration of a sample in an incineration crucible which was put into an incineration furnace at 580° C. for 2 hours. The ash content was measured as the total amount of remaining inorganic residues. The results are set out in the following table 8.

TABLE 8

| Sample | Expected (wt %) | Measured (wt %) |
|---|---|---|
| S3-PLA CC3 | 20 | 19.1 |
| S3-PLA CC2 | 20 | 19.8 |
| S3-PLA CC6 | 20 | 19.7 |
| S3-PLA CC7 | 20 | 19.7 |
| S3-PLA CC8 | 20 | 19.9 |
| S3-PLA CC9 | 20 | 19.8 |
| S3-PLA CC10 | 20 | 19.3 |
| S3-PLA CC5 | 20 | 19.9 |

The melt flow index of the PLA samples was measured and the results are set out in the following table 9.

TABLE 9

| Sample | Comment | MFI 210° C./2.16 kg (g/10 min) |
|---|---|---|
| S3-PLA CC0 | Unfilled PLA | 7.1 |
| S3-PLA CC3 | 20% CC3 | 6.1 |
| S3-PLA CC2 | 20% CC2 | 12.4 |
| S3-PLA CC6 | 20% CC6 | 66.7 |
| S3-PLA CC7 | 20% CC7 | 56.5 |
| S3-PLA CC8 | 20% CC8 | 7.0 |
| S3-PLA CC9 | 20% CC9 | 7.2 |
| S3-PLA CC10 | 20% CC10 | 21.6 |
| S3-PLA CC5 | 20% CC5 | 15.7 |

The tensile properties were measured and the results are presented in the following table 10.

TABLE 10

| | E-Modulus | Tensile strength | Elongation at |
|---|---|---|---|
| Sample | (N/mm²) | (N/mm²) | break (%) |
| S3-PLA CC0 | 2890 | 75.5 | 4.5 |
| S3-PLA CC3 | 3510 | 54.1 | 27.2 |
| S3-PLA CC2 | 3760 | 53.5 | 9.4 |
| S3-PLA CC6 | 3820 | 66 | 2.3 |
| S3-PLA CC7 | 3670 | 66.4 | 2.5 |
| S3-PLA CC8 | 3650 | 53.2 | 12.8 |
| S3-PLA CC9 | 3860 | 55.3 | 7.2 |
| S3-PLA CC10 | 3700 | 59.8 | 4.9 |
| S3-PLA CC5 | 3820 | 65.6 | 3.3 |

The impact properties (Charpy, V-notched) were measured and the results are presented in the following table 11.

TABLE 11

| Sample | Impact strength (kJ/m²) |
|---|---|
| S3-PLA CC0 | 3.21 |
| S3-PLA CC3 | 7.3 |
| S3-PLA CC2 | 6.8 |
| S3-PLA CC6 | 3 |
| S3-PLA CC7 | 2.8 |
| S3-PLA CC8 | 9.5 |
| S3-PLA CC9 | 7 |
| S3-PLA CC10 | 3.5 |
| S3-PLA CC5 | 3.4 |

The color of the PLA samples was measured on polymer plates (40×40×5 mm) with a Spectro-guide 45/0 gloss device from BYK-Gardner GmbH. The results (average over 3 measurements) are presented in the following table 12.

TABLE 12

| | L* | a* | b* |
|---|---|---|---|
| S3-PLA CC3 | 88.44 | 0.43 | 5.14 |
| S3-PLA CC2 | 88.53 | 0.57 | 5.59 |
| S3-PLA CC6 | 90.19 | 0.70 | 7.96 |
| S3-PLA CC7 | 91.17 | 0.58 | 6.26 |
| S3-PLA CC8 | 90.78 | 0.81 | 6.88 |
| S3-PLA CC9 | 91.79 | 0.64 | 5.56 |
| S3-PLA CC10 | 89.98 | 1.02 | 7.29 |
| S3-PLA CC5 | 88.71 | 1.00 | 8.93 |

### 2. Pilot Trials in PLA

### Compounding and Injection

Compounds were produced on a Maris TM20HT corotating Twin Screw Extruder (I/d=1.55, L=48D) at 300 rpm. The PLA (Ingeo™ 2003D from Natureworks) was fed via the main feeder and the calcium carbonate via one side feeder which was placed at zone 4. Output was set to 5 kg/h.

The indicative temperature profile used for the process is set out in the following table 13.

TABLE 13

| | Zone | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Temper- | 100 | 180 | 175 | 170 | 180 | 180 | 175 | 180 | 180 | 170 | 180 | 180 | 190 |
| ature | | | | | | | | | | | | | |
| (° C.) | | | | | | | | | | | | | |

In the following table 14, the compound formulations are summarized. The polymer (PLA Ingeo 2003D) was dried 3 h at 60° C. before use.

TABLE 14

| | PLA | CC2 | CC3 | CC11 | CC13 | CC14 | CC12 |
|---|---|---|---|---|---|---|---|
| | (pbw) | (pbw) | (pbw) | (pbw) | (pbw) | (pbw) | (pbw) |
| S4-PLA CC0 | 100 | | | | | | |
| S4-PLA CC2 | 80 | 20 | | | | | |
| S4-PLA CC3/20 | 80 | | 20 | | | | |
| S4-PLA CC11 | 80 | | | 20 | | | |
| S4-PLA CC13 | 80 | | | | 20 | | |
| S4-PLA CC14 | 80 | | | | | 20 | |
| S4-PLA CC12/20 | 80 | | | | | | 20 |
| S4-PLA CC3/50 | 50 | | 50 | | | | |
| S4-PLA CC12/50 | 50 | | | | | | 50 |

For mechanical properties testing, sample specimens were produced by injection molding using a Xplore IM12 injection moulder from Xplore Instruments B.V with the settings indicated in the following table 15.

TABLE 15

| | | |
|---|---|---|
| Melt temperature | 210° C. | |
| Mould temperature | 65° C. | |
| Melting time | 3 min | |
| Pressure 1 + time | 7 bars | 1 s |
| Pressure 2 + time | 7 to 8 bars | 2 s |
| Pressure 3 + time | 8 bars | 10 s |

The ash content in [%] of the compounds was determined by incineration of a sample in an incineration crucible which is put into an incineration furnace following the temperature cycles described in the following table 16.

TABLE 16

| | 1 | 2 | 3 | 4 |
|---|---|---|---|---|
| Temperature (° C.) | 330 | 480 | 570 | 570 |
| Time (min) | 85 | 100 | 25 | 120 |
| Ramp (° C./min) | 3.6 | 1.5 | 3.6 | 0 |
| Ventilation | — | on | on | — |

The ash content was measured as the total amount of remaining inorganic residues. The results are set out in the following table 17.

TABLE 17

| Sample | Expected (wt %) | Measured (wt %) |
|---|---|---|
| S4-PLA CC2 | 20 | 19.1 |
| S4-PLA CC3/20 | 20 | 18.7 |
| S4-PLA CC11 | 20 | 19.6 |
| S4-PLA CC13 | 20 | 19.2 |
| S4-PLA CC14 | 20 | 19.3 |
| S4-PLA CC12/20 | 20 | 19.3 |
| S4-PLA CC3/50 | 50 | 49.3 |
| S4-PLA CC12/50 | 50 | 48.7 |

The melt flow index was measured and the results are set out in the following table 18.

TABLE 18

| | | MFI 210° C./2.16 |
|---|---|---|
| Sample | Comment | kg (g/10 min) |
| S4-PLA CC0 | Unfilled PLA | 6.6 |
| S4-PLA CC2 | 20% CC2 | 15.5 |
| S4-PLA CC3/20 | 20% CC3 | 5.8 |
| S4-PLA CC11 | 20% CC11 | 15.1 |
| S4-PLA CC13 | 20% CC13 | 14.9 |
| S4-PLA CC14 | 20% CC14 | 5.2 |
| S4-PLA CC12/20 | 20% CC12 | 5.3 |
| S4-PLA CC3/50 | 20% CC3 | 5.1 |
| S4-PLA CC12/50 | 50% CC12 | 3.6 |

Very surprisingly, despite the moisture level of its raw material (CC5), high biobased content treated precipitated calcium carbonates S4-PLA CC12/20 and S4-PLA CC12/50 give lower MFI than the standard, state of the art GCC products (respectively S4-PLA CC3/20 and S4-PLA CC3/50).

The tensile properties were measured and the results are presented in the following table 19.

TABLE 19

| | E-Modulus | Max. strength | Elongation |
|---|---|---|---|
| Sample | (N/mm²) | (N/mm²) | at break (%) |
| S4-PLA CC0 | 3250 | 74.5 | 4.3 |
| S4-PLA CC2 | 4090 | 549 | 14.3 |
| S4-PLA CC3/20 | 4030 | 55.1 | 19 |
| S4-PLA CC11 | 3990 | 69.8 | 2.7 |
| S4-PLA CC13 | 3950 | 55.3 | 9.2 |
| S4-PLA CC14 | 3740 | 55.4 | 30.5 |
| S4-PLA CC12/20 | 3800 | 53.8 | 26.2 |

Very surprisingly, high biobased content treated precipitated calcium carbonates S4-PLA CC12/20 and S4-PLA CC14 give higher elongation at break than the standard GCC products S4-PLA CC3/20 and S4-PLA CC2).

The impact properties (Charpy, V-notched) were measured and the results are presented in the following table 20.

TABLE 20

| | Impact strength |
|---|---|
| Sample | (kJ/m²) |
| S4-PLA CC0 | 3.23 |
| S4-PLA CC2 | 5.42 |
| S4-PLA CC3/20 | 5.95 |
| S4-PLA CC11 | 2.97 |
| S4-PLA CC13 | 5.04 |
| S4-PLA CC14 | 5.68 |
| S4-PLA CC12/20 | 6.45 |

Very surprisingly, high biobased content treated precipitated calcium carbonates S4-PLA CC12/20 give higher impact performance than the standard GCC product S4-PLA CC3/20 and S4-PLA CC2.

The color of the PLA samples was measured on polymer plates (40×40×5 mm) with a Spectro-guide 45/0 gloss device from BYK-Gardner GmbH. The results (average over 3 measurements) are presented in the following table 21.

TABLE 21

| | L* | a* | b* |
|---|---|---|---|
| S4-PLA CC0 | 43.98 | −0.40 | 5.01 |
| S4-PLA CC2 | 88.49 | 0.34 | 5.63 |
| S4-PLA CC3/20 | 89.45 | 0.22 | 4.49 |
| S4-PLA CC11 | 90.11 | 0.93 | 8.27 |
| S4-PLA CC13 | 89.78 | 0.61 | 7.98 |
| S4-PLA CC14 | 91.49 | 0.50 | 5.88 |
| S4-PLA CC12/20 | 91.46 | 0.23 | 7.00 |

### 3. Lab Trials in PHBV

### Compounding and Injection

Compounding in poly(3-hydroxybutyrate-co-3-hydroxyvalerate) (PHBV; Enmat Y1000P from PHAradox) was performed on a lab twin screw extruder.

### Extrusion Conditions:

Twin-screw extruder 25:1 from Three Tec (Extruder Type ZE12, die: 0.5 mm)
T1=165° C.
T2=170° C.
T3=173° C.
T4=175° C.

The samples compounded are summarized in the following table 22.

TABLE 22

| | PHBV | CC1 | CC2 | CC3 | CC11 | CC12 | CC13 |
|---|---|---|---|---|---|---|---|
| Sample | (pbw) | (pbw) | (pbw) | (pbw) | (pbw) | (pbw) | (pbw) |
| S5-PHBV CC0 | 100 | | | | | | |
| S5-PHBV CC1 | 80 | 20 | | | | | |
| S5-PHBV CC2 | 80 | | 20 | | | | |
| S5-PHBV CC3 | 80 | | | 20 | | | |
| S5-PHBV CC4 | 80 | | | | 20 | | |
| S5-PHBV CC5 | 80 | | | | | 20 | |
| S5-PHBV CC6 | 80 | | | | | | 20 |

For mechanical properties testing, sample specimens were produced by injection molding using a Xplore IM12 injection moulder from Xplore Instruments B.V with the settings indicated in the following table 23:

TABLE 23

| | | |
|---|---|---|
| Melt temperature | 195° C. | |
| Mould temperature | 60° C. | |
| Melting time | 3 min | |
| Pressure 1 + time | 7 bars | 1 s |
| Pressure 2 + time | 7 to 8 bars | 2 s |
| Pressure 3 + time | 8 bars | 10 s |

The ash content in [%] of the compounds was determined by incineration of a sample in an incineration crucible which was put into an incineration furnace at 580° C. for 2 hours. The ash content was measured as the total amount of remaining inorganic residues. The results are set out in the following table 24.

TABLE 24

| Sample | Expected (wt %) | Measured (wt %) |
|---|---|---|
| S5-PHBV CC1 | 20 | 18.8 |
| S5-PHBV CC2 | 20 | 19.2 |
| S5-PHBV CC3 | 20 | 20.0 |
| S5-PHBV CC4 | 20 | 19.3 |
| S5-PHBV CC5 | 20 | 21.5 |
| S5-PHBV CC6 | 20 | 19.6 |

The melt flow index of the PHBV samples was measured and the results are set out in the following table 25.

TABLE 25

| | | MFI 190° C./ |
|---|---|---|
| Sample | Comment | 2.16 kg (g/10 min) |
| S5-PHBV CC0 | Unfilled PHBV | 14.5 |
| S5-PHBV CC1 | 20% CC1 | 19.5 |
| S5-PHBV CC2 | 20% CC2 | 26.0 |
| S5-PHBV CC3 | 20% CC3 | 15.6 |
| S5-PHBV CC4 | 20% CC11 | 15.4 |
| S5-PHBV CC5 | 20% CC12 | 13.8 |
| S5-PHBV CC6 | 20% CC13 | 28.0 |

The tensile properties were measured and the results are presented in the following table 26.

TABLE 26

| | E-Modulus | Tensile strength | Elongation at break |
|---|---|---|---|
| Sample | (N/mm²) | (N/mm²) | (%) |
| S5-PHBV CC0 | 1740 | 20.5 | 2.6 |
| S5-PHBV CC1 | 2310 | 18.5 | 1.5 |
| S5-PHBV CC2 | 2430 | 18.1 | 1.6 |
| S5-PHBV CC3 | 2360 | 18.6 | 2.1 |
| S5-PHBV CC4 | 2320 | 18.3 | 1.6 |
| S5-PHBV CC5 | 2180 | 17.5 | 2.0 |
| S5-PHBV CC6 | 2300 | 17.7 | 1.6 |

The impact properties (Charpy, V-notched) were measured according to ISO 179-1eA: 2010-11 on a HIT5.5P device from Zwick Roell. Measurements were performed on V-notched samples with a hammer of 2 J. All measurements were performed on samples that have been stored under similar conditions after preparation. The results from impact tests are presented in the following table 27.

TABLE 27

| Sample | Impact strength (kJ/m²) |
|---|---|
| S5-PHBV CC0 | 2.84 |
| S5-PHBV CC1 | 3.31 |
| S5-PHBV CC2 | 3.41 |
| S5-PHBV CC3 | 3.22 |
| S5-PHBV CC4 | 2.61 |
| S5-PHBV CC5 | 3.34 |
| S5-PHBV CC6 | 2.19 |

The color of the PLA samples was measured on polymer plates (40×40×5 mm) with a Spectro-guide 45/0 gloss device from BYK-Gardner GmbH. The results (average over 3 measurements) are presented in the following table 28.

TABLE 28

| | L* | a* | b* |
|---|---|---|---|
| S5-PHBV CC0 | 62.347 | 1.323 | 16.200 |
| S5-PHBV CC1 | 82.490 | 1.577 | 10.497 |
| S5-PHBV CC2 | 81.793 | 1.827 | 9.980 |
| S5-PHBV CC3 | 82.093 | 1.760 | 9.347 |
| S5-PHBV CC4 | 82.527 | 1.940 | 10.657 |
| S5-PHBV CC5 | 82.997 | 1.823 | 11.220 |
| S5-PHBV CC6 | 82.697 | 0.987 | 9.53 |

### 4. Lab Trials in PET

### Compounding and Injection

Compounding in polyethylene terephthalate (PET; Lighter C93 from Dow Chemical) was performed on a lab twin screw extruder. PET was dried 3 hours at 80° C. before compounding.

### Extrusion Conditions:

Twin-screw extruder 25:1 from Three Tec (Extruder Type ZE12, die: 0.5 mm)
T1=255° C.
T2=265° C.
T3=265° C.
T4=260° C.

The samples compounded are summarized in the following table 29.

TABLE 29

| | PET | CC3 | CC2 | CC12 |
|---|---|---|---|---|
| Sample | (pbw) | (pbw) | (pbw) | (pbw) |
| S6-PET CC0 | 100 | | | |
| S6-PET CC1 | 75 | 25 | | |
| S6-PET CC2 | 75 | | 25 | |
| S6-PET CC3 | 75 | 25 | | |

The ash content in [%] of the compounds was determined by incineration of a sample in an incineration crucible which was put into an incineration furnace at 580° C. for 2 hours. The ash content was measured as the total amount of remaining inorganic residues. The results are set out in the following table 30.

TABLE 30

| Sample | Expected (wt %) | Measured (wt %) |
|---|---|---|
| S6-PET CC1 | 25 | 23.6 |
| S6-PET CC2 | 25 | 24.3 |
| S6-PET CC3 | 25 | 24.2 |

The viscosity of the PET samples was measured and the results are set out in the following table 31.

TABLE 31

| Sample | Comment | Viscosity (Pa · s) |
|---|---|---|
| S6-PET CCO | Unfilled PET | 128 |
| S6-PET CC2 | 25% CC2 | 113 |
| S6-PET CC3 | 25% CC12 | 127 |

### 5. Trials in Polyolefins Breathable Films

### Compounding and Film Extrusion:

### Preparation of Compounds (CO):

Compounds containing 50 wt.-% CC3 or CC12 or CC13, respectively, were continuously prepared on a lab scale Buss kneader (PR46 from Buss AG, Switzerland). The obtained compounds were pelletized on a spring load pelletizer, model SLC (Gala, USA) in a water bath having a starting temperature between 2° and 25° C. The compositions and filler contents of the prepared compounds are compiled in Table 32 below. The precise filler content was determined by the ash content.

### Preparation of Breathable Films

Breathable films were produced by a pilot-extrusion cast-film line with integrated MDO-II unit (Dr. Collin GmbH, Germany). The polymer compounds were dried for 2 hours at 80° C. in a Motan dry air dryer MD40 before extrusion. The extruder temperature settings were 195° C.-210° C.-230° C.-230° C., and the rotation speed of the extruder screw was 35 rpm, using the compounds described in Table 32. The die gap was set at 0.85 mm. When changing the compound sample, the extrusion was run for 15 minutes to purge the former compound. The chill roll was at 45° C. The speed of the chill roll was at 3 to 5 m/min. It was adjusted to match the desired film grammage. The stretching roll temperature was at 60° C. The stretching ratio of the stretching unit was increased until a homogeneously stretched film was achieved.

TABLE 32

| | PE 1 | PE 2 | CC3 | CC12 | CC13 |
|---|---|---|---|---|---|
| Sample | (pbw) | (pbw) | (pbw) | (pbw) | (pbw) |
| S7-PE F0 | 45 | 5 | 50 | | |
| S7-PE F1 | 45 | 5 | | 50 | |
| S7-PE F2 | 45 | 45 | | | 50 |

The ash content in [%] of the compounds was determined by incineration of a sample in an incineration crucible which was put into an incineration furnace at 580° C. for 2 hours. The ash content was measured as the total amount of remaining inorganic residues. The results are set out in the following table 33.

TABLE 33

| Sample | Expected (wt %) | Measured (wt %) |
|---|---|---|
| S7-PE F0 | 50 | 49.6 |
| S7-PE F1 | 50 | 48.8 |
| S7-PE F2 | 50 | 49.1 |

The filter pressure value (FPV) test method was measured and the results are set out in the following table 34.

TABLE 34

| Sample | Comment | FPV (bar/g) |
|---|---|---|
| S7-PE F0 | 50% CC3 | 0.09 |
| S7-PE F1 | 50% CC12 | 0.09 |
| S7-PE F2 | 50% CC13 | 0.18 |

The moisture content of the pellets was measured and the results are set out in the following table 35.

TABLE 35

| Sample | Comment | Moisture (ppm) |
|---|---|---|
| S7-PE F0 | 50% CC3 | 153 |
| S7-PE F1 | 50% CC12 | 131 |
| S7-PE F2 | 50% CC13 | 89 |

The water vapour transmission rate (WVTR) was measured and the results are set out in the following table 36.

TABLE 36

| Sample | Comment | WVTR (m/m²) |
|---|---|---|
| S7-PE F0 | 50% CC3 | 3969 |
| S7-PE F1 | 50% CC12 | 3845 |
| S7-PE F2 | 50% CC13 | 3867 |

The oxidative oxidation time was measured and the results are set out in the following table 37.

TABLE 37

| Sample | Comment | OIT (min) |
|---|---|---|
| S7-PE F0 | 50% CC3 | 10.3 |
| S7-PE F1 | 50% CC12 | 16.6 |

### 5. Lab Trials in Polyolefins:

### Film Extrusion

Each film was produced via a twin-screw extruder 25:1 from Three Tec (Extruder Type ZE12, die: 0.5 mm) combined with a calander. The polymer used was a polypropylene PP HF700SA from Borealis.

### Extrusion Conditions:

Twin-screw extruder 25:1 from Three Tec (Extruder Type ZE12, die: 0.5 mm)
T1=210° C.
T2=230° C.
T3=230° C.
T4=210° C.

The films produced are summarized in the following table 38.

TABLE 38

| | PP | CC2 | CC3 | CC12 | CC13 |
|---|---|---|---|---|---|
| Sample | (pbw) | (pbw) | (pbw) | (pbw) | (pbw) |
| S8-PP F0 | 100 | | | | |
| S8-PP F1 | 90 | 10 | | | |
| S8-PP F2 | 90 | | 10 | | |
| S8-PP F3 | 90 | | | 10 | |
| S8-PP F4 | 90 | | | 10 | |

The ash content in [%] of the compounds was determined by incineration of a sample in an incineration crucible which was put into an incineration furnace at 580° C. for 2 hours. The ash content was measured as the total amount of remaining inorganic residues. The results are set out in the following table 39.

TABLE 39

| Sample | Expected (wt %) | Measured (wt %) |
|---|---|---|
| S8-PP F1 | 10 | 9.1 |
| S8-PP F2 | 10 | 9.6 |
| S8-PP F3 | 10 | 8.6 |
| S8-PP F4 | 10 | 8.7 |

The tensile properties were measured and the results are presented in the following table 40.

TABLE 40

| | E-Modulus | Tensile strength | Elongation at break |
|---|---|---|---|
| Sample | (N/mm²) | (N/mm²) | (%) |
| S8-PP F0 | 1560 | 56.1 | 132 |
| S8-PP F1 | 1550 | 47.6 | 84 |
| S8-PP F2 | 1530 | 50.1 | 74 |
| S8-PP F3 | 1560 | 48.1 | 70 |
| S8-PP F4 | 1600 | 49.4 | 67 |

Surprisingly the inventive high biobased content treated precipitated calcium carbonates performs as good as standard ground natural calcium carbonates.

1.-20. (canceled)

21. A precipitated calcium carbonate having
a weight median particle size d₅₀ of ≤60 μm,
a top cut particle size d₉₈ of ≤500 μm, and
a residual total moisture content of ≤0.5 wt.-%, based on the total dry weight of the precipitated calcium carbonate,
wherein the precipitated calcium carbonate has a content of bio-based carbon determined according to DIN EN 16640:2017 of at least 50 wt.-%, based on the total weight of carbon in the precipitated calcium carbonate.

22. The precipitated calcium carbonate of claim 21, wherein the precipitated calcium carbonate has
a weight median particle size d₅₀ of ≤2 μm, and/or
a top cut particle size d₉₈ of ≤8 μm, and/or
a specific surface area (BET) in the range from 1 to 50 m²/g, as measured using nitrogen and the BET method according to ISO 9277, and/or
a residual total moisture content of ≤0.1 wt.-%, based on the total dry weight of the precipitated calcium carbonate, and/or
a content of bio-based carbon determined according to DIN EN 16640:2017 of at least 70 wt.-%, based on the total weight of carbon in the precipitated calcium carbonate.

23. The precipitated calcium carbonate of claim 21, wherein the precipitated calcium carbonate is obtained from water decarbonization and/or water softening.

24. The precipitated calcium carbonate of claim 21, wherein the precipitated calcium carbonate is a treated precipitated calcium carbonate comprising a treatment layer on the surface of the precipitated calcium carbonate.

25. The precipitated calcium carbonate of claim 21, wherein the precipitated calcium carbonate is a treated precipitated calcium carbonate comprising a treatment layer on the surface of the precipitated calcium carbonate, and wherein the treatment layer comprises a surface-treatment agent selected from the group consisting of
I) a phosphoric acid ester blend of one or more phosphoric acid mono ester and/or salts or reaction products thereof and/or one or more phosphoric acid di-ester and/or salts or reaction products thereof, or
II) at least one saturated or unsaturated aliphatic linear or branched carboxylic acid and/or salts or reaction products thereof, or at least one aliphatic carboxylic acid having a total amount of carbon atoms from C4 to C24 and/or salts or reaction products thereof, or
III) at least one mono-substituted succinic anhydride consisting of succinic anhydride mono-substituted with a group selected from a linear, branched, aliphatic and cyclic group having a total amount of carbon atoms from at least C2 to C30 in the substituent and/or salts or reaction products thereof, and/or
IV) at least one polydialkylsiloxane, and/or
V) at least one cross-linkable compound comprising at least two functional groups, wherein at least one functional group is suitable for cross-linking a polymer resin and wherein at least one functional group is suitable for reacting with the precipitated calcium carbonate, and/or
VI) at least one grafted polymer comprising at least one succinic anhydride group obtained by grafting maleic anhydride onto a homo- or co-polymer comprising butadiene units and optionally styrene units and/or salts or reaction products thereof, or
VII) mixtures of one or more materials according to I) to VI).

26. The precipitated calcium carbonate of claim 24, wherein the treated precipitated calcium carbonate comprises the treatment layer in an amount ranging from 0.1 to 3 wt.-% based on the total weight of the treated precipitated calcium carbonate and/or in an amount ranging from 0.2 to 5.0 mg/m² of the BET specific surface area of the precipitated calcium carbonate.

27. The precipitated calcium carbonate material of claim 24, wherein the treated precipitated calcium carbonate has
a residual total moisture content of ≤0.3 wt.-%, based on the total dry weight of the treated precipitated calcium carbonate and/or
a moisture pick-up susceptibility of ≤6 mg/g, based on the total dry weight of the treated precipitated calcium carbonate.

28. A process for the preparation of the precipitated calcium carbonate according to claim 21, the process comprising the steps of:
a) providing a precipitated calcium carbonate having a content of bio-based carbon determined according to DIN EN 16640:2017 of at least 50 wt.-%, based on the total weight of carbon in the material and
b) grinding the precipitated calcium carbonate of step a) to a weight median particle size d₅₀ of ≤60 μm and to a top cut particle size d₉₈ of ≤500 μm.

29. The process of claim 28, wherein in the providing step a), the precipitated calcium carbonate having a content of bio-based carbon determined according to DIN EN 16640:2017 of at least 70 wt.-%, based on the total weight of carbon in the material.

30. The process of claim 28, wherein in the providing step a), the precipitated calcium carbonate is obtained from water decarbonisation and/or water softening.

31. The process of claim 28, wherein the grinding is carried out in the absence of dispersant(s).

32. The process of claim 28, wherein the grinding is a wet grinding at solids content in the range from 1 to 30 wt.-%.

33. The process of claim 28, further comprising step c) in which the precipitated calcium carbonate is contacted under mixing, in one or more steps, with a surface-treatment agent such that a treatment layer comprising the surface-treatment agent and/or salts or reaction products thereof is formed on the surface of the precipitated calcium carbonate.

34. The process of claim 33, wherein step c) is carried out at a temperature that is from 50 to 130° C.

35. The process of claim 33, further comprising
a step of drying the precipitated calcium carbonate before and/or after grinding step b) and optionally before surface-treating step c), and/or
a step of dry-grinding and/or wet-grinding the precipitated calcium carbonate before grinding step b).

36. A polymer formulation comprising
a) a polymer resin and
b) the precipitated calcium carbonate according to claim 21,
wherein the precipitated calcium carbonate is dispersed in the polymer resin.

37. The polymer formulation of claim 36, wherein the polymer resin comprises polyester, polyolefin, polyamide, polyethylene, polypropylene, polylactic acid, polylactic acid-based polymer, polyhydroxyalkanoates (PHA), polyhydroxybutyrate (PHB), poly-3-hydroxybutyrate (P3HB), poly3-hydroxybutyrate-co-3-hydroxyhexanoate (PHBH), polyhydroxyvalerate, polyhydroxybutyrate-polyhydroxyvalerate copolymer, poly(3-hydroxybutyrate-co-3-hydroxyvalerate) (PHBV), polybutyrate-adipate-terephthalate (PBAT), polyglyconate, polyethylene terephthalate (PET), polycarbonate (PC), poly(dioxanone), polybutylene succinate (PBS), polycaprolactone (PCL), polycaprolactone-poly(ethylene glycol) copolymer, polycaprolactone-polylactic acid copolymer, polyvinylalcohol (PVA), poly(ethylene succinate) (PES), poly(propylene succinate) (PPS), an elastomer resin, natural rubber, synthetic rubber, acrylic rubber, butadiene rubber, acrylonitrile-butadiene rubber, epichlorhydrin rubber, isoprene rubber, ethylene-propylene rubber, ethylene-propylene-diene monomer rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, thermoplastic starch (TPS), or mixtures thereof.

38. The polymer formulation of claim 36, wherein the polymer formulation comprises the precipitated calcium carbonate in an amount ranging from 3 to 85 wt.-%, based on the total weight of the formulation.

39. The polymer formulation of claim 36, wherein the polymer resin is a biobased polymer resin, a bio-based polyolefin, a bio-based thermoplastic starch, or a bio-based polyester.

40. An article formed from the polymer formulation according to claim 36.

41. The article of claim 40, wherein the article is selected from hygiene products, medical products, healthcare products, filter products, geotextile products, agriculture products, horticulture products, clothing, footwear products, baggage products, household products, industrial products, packaging products, construction products, automotive parts, bottles, cups, bags, straws, and flooring products.

42. A process for preparing an article according to claim 40, wherein the process comprises the steps of
a) providing the polymer resin,
b) providing the precipitated calcium carbonate as filler,
c) optionally providing further additives, colouring pigments, fibers, cellulose fibers, glass fibers, wood fibers, dyes, waxes, lubricants, oxidative-stabilizers, UV-stabilizers, antioxidants, other fillers, carbon black, TiO₂, mica, clay, precipitated silica, talc, or calcined kaolin,
d) contacting the components of step a), step b), and optionally step c) in any order to form the polymer formulation, and
e) forming the polymer formulation of step d) such that the article is obtained.
